(19) United States
(12) Patent Application Publication
(10) Pub. No.: US 2024/0128455 A1
(43) Pub. Date: Apr. 18, 2024

(54) FIBRILLAR CARBON-SILICON COMPOSITE MATERIALS AND METHODS OF MANUFACTURE THEREOF

(71) Applicant: Aspen Aerogels, Inc., Northborough, MA (US)

(72) Inventors: Nicholas Zafiropoulos, Northborough, MA (US); Wendell Rhine, Belmont, MA (US); Zhifei Li, Marlborough, MA (US)

(21) Appl. No.: 18/546,423

(22) PCT Filed: Feb. 14, 2022
(86) PCT No.: PCT/IB2022/051302

§ 371 Date: Aug. 14, 2023

Related U.S. Application Data
(60) Provisional application No. 63/149,616, filed on Feb. 15, 2021.

(51) Int. Cl. H01M 4/587; H01M 4/04; H01M 4/36; H01M 4/38; H01M 10/0525

(52) U.S. Cl. CPC H01M 4/587; H01M 4/0471; H01M 4/366; H01M 4/386; H01M 10/0525; H01M 2004/027

(57) ABSTRACT

Carbon-silicon compositions including nanofibrillar carbon networks coated with porous interconnected silicon and their manufacture and use thereof are provided. Embodiments include a composite material including a nanoporous carbon-based scaffold and a silicon-based material. The nanoporous carbon-based scaffold includes a pore structure that includes a fibrillar morphology, where the silicon-based material is contained in the pore structure. The compositions find utility in various applications, including electrical energy storage electrodes and devices comprising the same.

### FIELD

This invention relates, generally, to nanoporous carbon-based materials. More specifically, it relates to fibrillar composite materials suitable for use in environments containing electrochemical reactions, for example as an electrode material within a lithium-ion battery.

### BACKGROUND

Lithium-based electrical storage devices have potential to replace devices currently used in any number of applications. Lithium ion batteries (LIBs) are a viable alternative to lead-based battery systems currently used due to their capacity, and other considerations. Carbon is one of the primary materials used in lithium-based electrical storage devices. Conventionally, the cathode is formed of lithium metal (e.g., cobalt, nickel, manganese) oxide, and the anode is formed of graphite, where lithium ions intercalate within graphite layers during charge (energy storage). However, such graphitic anodes typically suffer from low power performance and limited capacity.

It is known that silicon has a greater affinity for lithium compared to graphite (carbon) and is capable of storing significantly higher amounts of lithium than graphite during charging, theoretically resulting in higher capacity on the anode side of the LIB. By comparison, graphite has a theoretical capacity of 372 mAh/g in combination with lithium, whereas silicon has a theoretical capacity of 4200 mAh/g. These numbers have resulted in a desire to dispose as much silicon as possible within the anode.

In addition to silicon, tin and other electrochemically active species have also been proposed based on their ability to store very large amounts of lithium per unit weight. However, these materials, like silicon, are fundamentally limited by the substantial swelling that occurs when they are fully intercalated with lithium. This swelling and shrinkage when the lithium is removed results in an electrode that has limited cycle life and low power. The solution thus far has been to use very small amounts of alloying electrochemical modifier in a largely carbon electrode, but this approach does not impart the desired increase in lithium capacity. Finding a way to increase the alloying electrochemical modifier content in an anode composition while maintaining cycle stability is desired to increase capacity. A number of approaches have been utilized involving nano-structured alloying electrochemical modifier, blends of carbon with alloying electrochemical modifier, or deposition of alloying electrochemical modifier onto carbon using vacuum or high temperature. However, none of these processes has proven to combine a scalable process that results in the desired properties.

Recently, there has been effort devoted to the development and characterization of carbon aerogels as electrode materials with improved performance for applications in energy storage devices, such as lithium-ion batteries (LIBs). Aerogels are solid materials that include a highly porous network of micro-sized and meso-sized pores. Depending on precursor materials used and processing undertaken, the pores of an aerogel can frequently account for over 90% of the volume when the density of the aerogel about 0.05 g/cc. Aerogels can be formed of inorganic materials and/or organic materials. When formed of organic materials—such as phenols, resorcinol-formaldehyde (RF), phloroglucinol furfuraldehyde (PF), polyacrylonitrile (PAN), polyimide (PI), polyurethane (PU), polybutadiene, polydicyclopentadiene, and precursors or polymeric derivatives thereof, for example—the aerogel may be carbonized (e.g., by pyrolysis) to form a carbon aerogel, which can have properties (e.g., pore volume, pore size distribution, morphology, etc.) that differ or overlap from each other, depending on the precursor materials and methodologies used. However, in all cases, there have been certain deficiencies based on material and application, for example low pore volume, wide pore size distribution, low mechanical strength, etc.

Accordingly, what is needed is an improved nanoporous carbon material that includes a functional morphology and optimal pore structure to serve as a host for electrochemical modifiers to increase capacity, while resolving at least one of the issues discussed above. However, in view of the art considered as a whole at the time the present invention was made, it was not obvious to those of ordinary skill in the field of this invention how the shortcomings of the prior art could be overcome.

While certain aspects of conventional technologies have been discussed to facilitate disclosure of the invention, Applicants in no way disclaim these technical aspects, and it is contemplated that the claimed invention may encompass one or more of the conventional technical aspects discussed herein, especially in combination with the innovative aspects described herein.

The present invention may address one or more of the problems and deficiencies of the art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### SUMMARY

The long-standing but heretofore unfulfilled need for an improved nanoporous carbon composition is now met by a new, useful, and nonobvious invention.

In general, the technology is directed to carbon-silicon compositions and methods of forming carbon-silicon compositions. The methods generally include infiltrating the pore structure of the carbon-based scaffolds with a silicon-containing gas and depositing silicon-based material onto surfaces within the pore structure to form carbon-silicon composition. The carbon-silicon compositions generally include nanoporous carbon-based scaffolds including a silicon-based material contained within the fibrillar structure of the carbon-based scaffolds.

A first general aspect relates to a carbon-silicon composition. In an exemplary embodiment, the composition includes a composite material. The composite material includes a nanoporous carbon-based scaffold and a silicon-based material. In an exemplary embodiment, the nanoporous carbon-based scaffold includes a pore structure, the pore structure including a fibrillar morphology, wherein the silicon-based material is contained in the pore structure of the nanoporous carbon-based scaffold. For example, the composite material includes a porous interconnected silicon coated fibrillar carbon network. For another example, the composite material includes a fibrillar carbon network coated with porous interconnected silicon. For yet another example, the composite material includes a fibrillar network comprising silicon coated carbon.

In certain embodiments, the nanoporous carbon-based scaffold includes a carbon aerogel. For example, the nanoporous carbon-based scaffold can include a polyimide-derived carbon aerogel. The nanoporous carbon-based scaffold can be in a monolith or a powder form. In some exemplary embodiments, the silicon-based material is in the form of nanoparticles dispersed on the surface of the pore structure. For example, the nanoparticles can have at least one dimension less than about 1 μm. For another example, the nanoparticles can have at least one dimension in the range of about 5 nm to about 20 nm. In certain embodiments, the silicon-based material can be in the form of nanoparticles having at least one dimension of about 10 nm.

In exemplary embodiments, the silicon-based material is in the form of a layer on the surface of the pore structure. For example, the thickness of the layer can less than about 1 μm. For another example, the thickness of the layer can in the range of about 5 nm to about 20 nm. For another example, the thickness of the layer can be in the range of about 10 nm.

In exemplary embodiments, the pore structure of the nanoporous carbon-based scaffold includes less than 30% micropores, less than 30% macropores, greater than 50% mesopores and a total pore volume greater than 0.1 cc/g. In some embodiments, the pore structure of the nanoporous carbon-based scaffold includes less than 20% micropores, less than 20% macropores, greater than 70% mesopores and a total pore volume greater than 0.1 cc/g. In some embodiments, the pore structure of the nanoporous carbon-based scaffold includes less than 10% micropores, less than 10% macropores, greater than 80% mesopores and a total pore volume greater than 0.1 cc/g.

A second general aspect provides a method for preparing a carbon-silicon composition. In an exemplary embodiment, the process includes providing a nanoporous carbon-based scaffold comprising a pore structure, the pore structure comprising a fibrillar morphology and heating the nanoporous carbon-based scaffold at an elevated temperature in the presence of a silicon-containing gas to impregnate silicon within the pore structure of the nanoporous carbon-based scaffold.

In exemplary embodiments, the silicon impregnated within the pore structure of the nanoporous carbon-based scaffold is nano sized, and resides within pores formed by the fibrillar morphology. In exemplary embodiments, the nanoporous carbon-based scaffold includes a particulate carbon aerogel. For example, the carbon-silicon composition includes a porous interconnected silicon coated fibrillar carbon network. For another example, the carbon-silicon composition includes a fibrillar carbon network coated with porous interconnected silicon. For yet another example, the carbon-silicon composition includes a fibrillar network comprising silicon coated carbon.

In exemplary embodiments, the method further includes providing a polyimide precursor, initiating imidization of the polyimide precursor chemically or thermally; combining the polyimide precursor with a medium that is non-miscible with the polyimide precursor, thereby forming droplets of the imidized polyimide; drying the droplets of the polyimide to yield a particulate porous polyimide material; and carbonizing the particulate porous polyimide material to provide the nanoporous carbon-based scaffold.

In exemplary embodiments, the pore structure of the nanoporous carbon-based scaffold includes less than 30% micropores, less than 30% macropores, greater than 50% mesopores and a total pore volume greater than 0.1 cc/g. In some embodiments, the pore structure of the nanoporous carbon-based scaffold includes less than 20% micropores, less than 20% macropores, greater than 70% mesopores and a total pore volume greater than 0.1 cc/g. In some embodiments, the pore structure of the nanoporous carbon-based scaffold includes less than 10% micropores, less than 10% macropores, greater than 80% mesopores and a total pore volume greater than 0.1 cc/g.

A further embodiment provides an electrode including the carbon-silicon composition as described. For example, this electrode may be the anode. Another embodiment provides an energy storage device including the carbon-silicon composition as described, such as a battery or more specifically a lithium-ion battery.

Features which are described in the context of separate aspects and embodiments of the invention may be used together and/or be interchangeable. Similarly, features described in the context of a single embodiment may also be provided separately or in any suitable subcombination.

These and other important objects, advantages, and features of the invention will become clear as this disclosure proceeds.

### BRIEF DESCRIPTION OF THE DRAWINGS

For a full and clear understanding of the invention, reference should be made to the following detailed description, taken in connection with the accompanying drawings, in which:

FIG. 1 is a flow diagram illustrating an exemplary method according to embodiments disclosed herein;

FIG. 2 is a flow diagram illustrating another exemplary method according to embodiments disclosed herein;

FIG. 3 is a SEM image of a polyimide aerogel exhibiting a fibrillar morphology according to embodiments disclosed herein;

FIG. 4 is a SEM image of a carbon aerogel exhibiting a fibrillar morphology according to embodiments disclosed herein.

### DETAILED DESCRIPTION

Before describing several example embodiments of the technology, it is to be understood that the technology is not limited to the details of construction or process steps set forth in the following description. The technology is capable of other embodiments and of being practiced or being carried out in various ways.

In general, the technology is directed to carbon-silicon compositions and methods of forming carbon-silicon compositions. The methods generally include infiltrating the pore structure of the carbon-based scaffolds with a silicon-containing gas and depositing silicon-based material onto surfaces within the pore structure to form carbon-silicon composition. The carbon-silicon compositions generally include nanoporous carbon-based scaffolds including a silicon-based material contained within the fibrillar structure of the carbon-based scaffolds.

With respect to the terms used in this disclosure, the following definitions are provided. This application will use the following terms as defined below unless the context of the text in which the term appears requires a different meaning.

The articles “a” and “an” are used herein to refer to one or to more than one (i.e., to at least one) of the grammatical object of the article. The term “about” used throughout this specification is used to describe and account for small fluctuations. For example, the term “about” can refer to less than or equal to ±10%, or less than or equal to ±5%, such as less than or equal to ±2%, less than or equal to ±1%, less than or equal to ±0.5%, less than or equal to ±0.2%, less than or equal to ±0.1% or less than or equal to ±0.05%. All numeric values herein are modified by the term “about,” whether or not explicitly indicated. A value modified by the term “about” of course includes the specific value. For instance, “about 5.0” must include 5.0.

Within the context of the present disclosure, the terms “framework” or “framework structure” refer to the network of interconnected oligomers, polymers, or colloidal particles that form the solid structure of a gel or an aerogel. The polymers or particles that make up the framework structures typically have a diameter of about 100 angstroms. However, framework structures of the present disclosure can also include networks of interconnected oligomers, polymers, or colloidal particles of all diameter sizes that form the solid structure within in a gel or aerogel.

As used herein, the term “aerogel” or “aerogel material” refers to a solid object, irrespective of shape or size, comprising a framework of interconnected solid structures, with a corresponding network of interconnected pores integrated within the framework, and containing gases such as air as a dispersed interstitial medium. As such, aerogels are open non-fluid colloidal or polymer networks that are expanded throughout their whole volume by a gas, and are formed by the removal of all swelling agents from a corresponding wet-gel without substantial volume reduction or network compaction. Aerogels are generally characterized by the following physical and structural properties (according to nitrogen porosimetry testing and helium pycnometry) attributable to aerogels: (a) an average pore diameter ranging from about 2 nm to about 100 nm; (b) a porosity of at least 60% or more, and (c) a specific surface area of about 100 m²/g or more, such as from about 100 to about 600 m²/g by nitrogen sorption analysis. It can be understood that the inclusion of additives, such as a reinforcement material or an electrochemically active species, for example, silicon, may decrease porosity and the specific surface area of the resulting aerogel composite. Densification may also decrease porosity of the resulting aerogel composite. Aerogel materials of the present disclosure (e.g., polyimide and carbon aerogels) include any aerogels which satisfy the defining elements set forth in the previous paragraph.

Aerogel materials of the present disclosure thus include any aerogels or other open-celled compounds, which satisfy the defining elements set forth in previous paragraphs, including compounds, which can be otherwise categorized as xerogels, cryogels, ambigels, microporous materials, and the like. Aerogel materials of the present disclosure also include materials including a combination of aerogel and xerogel in the same composition, e.g., for controlled gradients of porosity.

As used herein, the term “xerogel” refers to a gel comprising an open, non-fluid colloidal or polymer networks that is formed by the removal of all swelling agents from a corresponding gel without or substantially without any precautions taken to avoid substantial volume reduction or to retard compaction. In contrast to an aerogel, a xerogel generally comprises a compact structure. Xerogels suffer substantial volume reduction during ambient pressure drying, and have surface areas of 0-100 m²/g, such as from about 0 to about 20 m²/g as measured by nitrogen sorption analysis.

As used herein, the term “gelation” or “gel transition” refers to the formation of a wet-gel from a polymer system, e.g., a polyimide or polyamic acid as described herein. At a point in the polymerization or dehydration reactions as described herein, which is defined as the “gel point,” the sol loses fluidity. Without intending to be bound to any particular theory, the gel point may be viewed as the point where the gelling solution exhibits resistance to flow. In the present context, gelation proceeds from an initial sol state, where the solution comprises primarily the amine salt of the polyamic acid, through a fluid colloidal dispersion state, until sufficient polyimide has formed to reach the gel point. Gelation may continue thereafter, producing a polyimide wet-gel dispersion of increasing viscosity. The amount of time it takes for the polymer (i.e., polyamic acid and/or polyimide) in solution to transform into a gel in a form that can no longer flow is referred to as the “phenomenological gelation time.” Formally, gelation time is measured using rheology. At the gel point, the elastic property of the solid gel starts dominating over the viscous properties of the fluid sol. The formal gelation time is near the time at which the real and imaginary components of the complex modulus of the gelling sol cross. The two moduli are monitored as a function of time using a rheometer. Time starts counting from the moment the last component of the sol is added to the solution. See, for example, discussions of gelation in H. H. Winter “Can the Gel Point of a Cross-linking Polymer Be Detected by the G′-G” Crossover?″ Polym. Eng. Sci., 1987, 27, 1698-1702; S.-Y. Kim, D.-G. Choi and S.-M. Yang “Rheological analysis of the gelation behavior of tetraethylorthosilane/vinyltriethoxysilane hybrid solutions” Korean J. Chem. Eng., 2002, 19, 190-196; and M. Muthukumar “Screening effect on viscoelasticity near the gel point” Macromolecules, 1989, 22, 4656-4658.

As used herein, the term “wet-gel” refers to a gel in which the mobile interstitial phase within the network of interconnected pores is primarily comprised of a liquid phase such as a conventional solvent, liquefied gases such as liquid carbon dioxide, or a combination thereof. Aerogels typically require the initial production of a wet-gel, followed by processing and extraction to replace the mobile interstitial liquid phase in the gel with air or another gas. Examples of wet-gels include, but are not limited to: alcogels, hydrogels, ketogels, carbonogels, and any other wet-gels known to those in the art.

Within the context of the present disclosure, the term “density” refers to a measurement of the mass per unit volume of an aerogel material or composition. The term “density” generally refers to the true or skeletal density of an aerogel material, as well as the bulk density of an aerogel composition. Density is typically reported as kg/m³ or g/cm³. The skeletal density of a polyimide or carbon aerogel may be determined by methods known in the art, including, but not limited to helium pycnometry. The bulk density of a polyimide or carbon aerogel may be determined by methods known in the art, including, but not limited to: Standard Test Method for Dimensions and Density of Preformed Block and Board-Type Thermal Insulation (ASTM C303, ASTM International, West Conshohocken, Pa.); Standard Test Methods for Thickness and Density of Blanket or Batt Thermal Insulations (ASTM C167, ASTM International, West Conshohocken, Pa.); or Determination of the apparent density of preformed pipe insulation (ISO 18098, International Organization for Standardization, Switzerland). Within the context of the present disclosure, density measurements are acquired according to ASTM C167 standards, unless otherwise stated. In some embodiments, aerogel materials or compositions of the present disclosure have a density of about 1.50 g/cc or less, about 1.40 g/cc or less, about 1.30 g/cc or less, about 1.20 g/cc or less, about 1.10 g/cc or less, about 1.00 g/cc or less, about 0.90 g/cc or less, about 0.80 g/cc or less, about 0.70 g/cc or less, about 0.60 g/cc or less, about 0.50 g/cc or less, about 0.40 g/cc or less, about 0.30 g/cc or less, about 0.20 g/cc or less, about 0.10 g/cc or less, or in a range between any two of these values, for example between about 0.15 g/cc and 1.5 g/cc or more particularly 0.50 g/cc and 1.30 g/cc.

Within the context of the present disclosure, the term “electrochemically active species” refers to an additive that is capable of accepting and releasing ions within an energy storage device. Using LIBs as an example, an electrochemically active species within the anode accepts lithium ions during charge and releases lithium ions during discharge. The electrochemically active species can be stabilized within the anode by having a direct/physical connection with the nanoporous carbon. In certain embodiments, the nanoporous carbon network forms interconnected structures around the electrochemically active species. The electrochemically active species is connected to the nanoporous carbon at a plurality of points. An example of an electrochemically active species is silicon, which expands upon lithiation and can crack or break, as previously noted. However, because silicon has multiple connection points with the nanoporous carbon (aerogel), silicon can be retained and remain active within the nanoporous structure, e.g., within the pores or otherwise encased by the structure, even upon breaking or cracking.

In certain embodiments, the electrochemically active species comprises an element with the ability to lithiate from 3 to 0 V versus lithium metal (e.g. silicon, tin, sulfur). In other embodiments, the electrochemically active species comprises metal oxides with the ability to lithiate from 3 to 0 V versus lithium metal (e.g. iron oxide, molybdenum oxide, titanium oxide). In still other embodiments, the electrochemically active species comprises elements which do not lithiate from 3 to 0 V versus lithium metal (e.g. aluminum, manganese, nickel, metal-phosphates). In yet other embodiments, the electrochemically active species comprises a non-metal element (e.g. fluorine, nitrogen, hydrogen). In still other embodiments, the electrochemically active species comprises any of the foregoing electrochemical modifiers or any combination thereof (e.g. tin-silicon, nickel-titanium oxide).

The electrochemically active species may be provided in any number of forms. For example, in some embodiments the electrochemically active species comprises a salt. In other embodiments, the electrochemically active species comprises one or more elements in elemental form, for example elemental iron, tin, silicon, nickel or manganese. In other embodiments, the electrochemically active species comprises one or more elements in oxidized form, for example iron oxides, tin oxides, silicon oxides, nickel oxides, aluminum oxides or manganese oxides.

In other embodiments, the electrochemically active species comprises iron. In other embodiments, the electrochemically active species comprises tin. In other embodiments, the electrochemically active species comprises silicon. In some other embodiments, the electrochemically active species comprises nickel. In yet other embodiments, the electrochemically active species comprises aluminum. In yet other embodiments, the electrochemically active species comprises manganese. In yet other embodiments, the electrochemically active species comprises Al2O3. In yet other embodiments, the electrochemically active species comprises titanium. In yet other embodiments, the electrochemically active species comprises titanium oxide. In yet other embodiments, the electrochemically active species comprises lithium. In yet other embodiments, the electrochemically active species comprises sulfur. In yet other embodiments, the electrochemically active species comprises phosphorous. In yet other embodiments, the electrochemically active species comprises molybdenum. In yet other embodiments, the electrochemically active species comprises germanium. In yet other embodiments, the electrochemically active species comprises arsenic. In yet other embodiments, the electrochemically active species comprises gallium. In yet other embodiments, the electrochemically active species comprises phosphorous. In yet other embodiments, the electrochemically active species comprises selenium. In yet other embodiments, the electrochemically active species comprises antimony. In yet other embodiments, the electrochemically active species comprises bismuth. In yet other embodiments, the electrochemically active species comprises tellurium. In yet other embodiments, the electrochemically active species comprises indium.

Within the context of the present disclosure, the terms “compressive strength”, “flexural strength”, and “tensile strength” refer to the resistance of a material to breaking or fracture under compression forces, flexure or bending forces, and tension or pulling forces, respectively. These strengths are specifically measured as the amount of load/force per unit area resisting the load/force. It is typically recorded as pounds per square inch (psi), megapascals (MPa), or gigapascals (GPa). Among other factors, the compressive strength, flexural strength, and tensile strength of a material collectively contribute to the material's structural integrity, which is beneficial, for example, to withstand volumetric expansion of silicon particles during lithiation in a LIB. Referring specifically to Young's modulus, which is an indication of mechanical strength, the modulus may be determined by methods known in the art, for example including, but not limited to: Standard Test Practice for Instrumented Indentation Testing (ASTM E2546, ASTM International, West Conshocken, PA); or Standardized Nanoindentation (ISO 14577, International Organization for Standardization, Switzerland). Within the context of the present disclosure, measurements of Young's modulus are acquired according to ASTM E2546 and ISO 14577, unless otherwise stated. In certain embodiments, aerogel materials or compositions of the present disclosure have a Young's modulus of about 0.2 GPa or more, 0.4 GPa or more, 0.6 GPa or more, 1 GPa or more, 2 GPa or more, 4 GPa or more, 6 GPa or more, 8 GPa or more, or in a range between any two of these values.

Within the context of the present disclosure, the term “pore size distribution” refers to the statistical distribution or relative amount of each pore size within a sample volume of a porous material. A narrower pore size distribution refers to a relatively large proportion of pores at a narrow range of pore sizes, thus optimizing the amount of pores that can surround the electrochemically active species and maximizing use of the pore volume. Conversely, a broader pore size distribution refers to relatively small proportion of pores at a narrow range of pore sizes. As such, pore size distribution is typically measured as a function of pore volume and recorded as a unit size of a full width at half max of a predominant peak in a pore size distribution chart. The pore size distribution of a porous material may be determined by methods known in the art, for example including, but not limited to, surface area and porosity analyzer by nitrogen adsorption and desorption from which pore size distribution can be calculated. Within the context of the present disclosure, measurements of pore size distribution are acquired according to this method, unless otherwise stated. In certain embodiments, aerogel materials or compositions of the present disclosure have a relatively narrow pore size distribution (full width at half max) of about 50 nm or less, 45 nm or less, 40 nm or less, 35 nm or less, 30 nm or less, 25 nm or less, 20 nm or less, 15 nm or less, 10 nm or less, 5 nm or less, or in a range between any two of these values. In some embodiments, materials have a ratio of the pore size of a predominant peak in a pore size distribution chart to the full width at half max of about 2:1. For example, for a material having a predominant peak in a pore size distribution chart in the range of about 2 nanometers to about 50 nanometers, the full width at half max can be in the range of about 25 nm to about 1 nm.

Within the context of the present disclosure, the term “mesopore” generally refers to pores having a diameter between about 2 nanometers and about 50 nanometers while the term “micropore” refers to pores having a diameter less than about 2 nanometers. Mesoporous carbon materials comprise greater than 50% of their total pore volume in mesopores while microporous carbon materials comprise greater than 50% of their total pore volume in micropores. Pores larger than about 50 nanometers are referred to as “macropores”.

Within the context of the present disclosure, the term “pore volume” refers to the total volume of pores within a sample of porous material. Pore volume is specifically measured as the volume of void space within the porous material, where that void space may be measurable and/or may be accessible by another material, for example an electrochemically active species such as silicon particles. It is typically recorded as cubic centimeters per gram (cm³/g or cc/g). The pore volume of a porous material may be determined by methods known in the art, for example including, but not limited to, surface area and porosity analyzer by nitrogen adsorption and desorption from which pore volume can be calculated. Within the context of the present disclosure, measurements of pore volume are acquired according to this method, unless otherwise stated. In certain embodiments, aerogel materials or compositions of the present disclosure (without incorporation of electrochemically active species, e.g., silicon) have a relatively large pore volume of about 1 cc/g or more, 1.5 cc/g or more, 2 cc/g or more, 2.5 cc/g or more, 3 cc/g or more, 3.5 cc/g or more, 4 cc/g or more, or in a range between any two of these values. In other embodiments, aerogel materials or compositions of the present disclosure (with incorporation of electrochemically active species, e.g., silicon) have a pore volume of about 0.3 cc/g or more, 0.6 cc/g or more, 0.9 cc/g or more, 1.2 cc/g or more, 1.5 cc/g or more, 1.8 cc/g or more, 2.1 cc/g or more, 2.4 cc/g or more, 2.7 cc/g or more, 3.0 cc/g or more, 3.3 cc/g or more, 3.6 cc/g or more, or in a range between any two of these values.

Within the context of the present disclosure, the term “porosity” refers to a volumetric ratio of pores that does not contain another material (e.g., an electrochemically active species such as silicon particles) bonded to the walls of the pores. For clarification and illustration purposes, it should be noted that within the specific implementation of silicon-doped carbon aerogel as the primary anodic material in a LIB, porosity refers to the void space after inclusion of silicon particles. As such, porosity may be, for example, about 10%-70% when the anode is in a pre-lithiated state (to accommodate for ion transport and silicon expansion) and about 1%-50% when the anode is in a post-lithiated state (to accommodate for ion transport). More generally, porosity may be determined by methods known in the art, for example including, but not limited to, the ratio of the pore volume of the aerogel material to its bulk density. Within the context of the present disclosure, measurements of porosity are acquired according to this method, unless otherwise stated. In certain embodiments, aerogel materials or compositions of the present disclosure have a porosity of about 80% or less, 70% or less, 60% or less, 50% or less, 40% or less, 30% or less, 20% or less, 10% or less, or in a range between any two of these values.

It should be noted that pore volume and porosity are different measures for the same property of the pore structure, namely the “empty space” within the pore structure. For example, when silicon is used as the electrochemically active species contained within the pores of the nanoporous carbon material, pore volume and porosity refer to the space that is “empty”, namely the space not utilized by the silicon or the carbon. As will be seen, densification, e.g., by compression, of the pre-carbonized nanoporous material can also have an effect on pore volume and porosity, among other properties.

Within the context of the present disclosure, the term “pore size at max peak from distribution” refers to the value at the discernible peak on a graph illustrating pore size distribution. Pore size at max peak from distribution is specifically measured as the pore size at which the greatest percentage of pores is formed. It is typically recorded as any unit length of pore size, for example micrometers or nm. The pore size at max peak from distribution may be determined by methods known in the art, for example including, but not limited to, surface area and porosity analyzer by nitrogen adsorption and desorption from which pore size distribution can be calculated and pore size at max peak can be determined. Within the context of the present disclosure, measurements of pore size at max peak from distribution are acquired according to this method, unless otherwise stated. In certain embodiments, aerogel materials or compositions of the present disclosure have a pore size at max peak from distribution of about 150 nm or less, 140 nm or less, 130 nm or less, 120 nm or less, 110 nm or less, 100 nm or less, 90 nm or less, 80 nm or less, 70 nm or less, 60 nm or less, 50 nm or less, 40 nm or less, 30 nm or less, 20 nm or less, 10 nm or less, 5 nm or less, 2 nm or less, or in a range between any two of these values. In some embodiments, materials have a ratio of the pore size of a predominant peak in a pore size distribution chart to the full width at half max of about 2:1. For example, for a material having a predominant peak in a pore size distribution chart in the range of about 2 nanometers to about 50 nanometers, the full width at half max can be in the range of about 25 nm to about 1 nm.

Within the context of the present disclosure, the term “strut width” refers to the average diameter of nanostruts, nanorods, nanofibers, or nanofilaments that form an aerogel having a fibrillar morphology. It is typically recorded as any unit length, for example micrometers or nm. The strut width may be determined by methods known in the art, for example including, but not limited to, scanning electron microscopy image analysis. Within the context of the present disclosure, measurements of strut width are acquired according to this method, unless otherwise stated. In certain embodiments, aerogel materials or compositions of the present disclosure have a strut width of about 10 nm or less, 9 nm or less, 8 nm or less, 7 nm or less, 6 nm or less, 5 nm or less, 4 nm or less, 3 nm or less, 2 nm or less, or in a range between any two of these values. An exemplary range of strut widths found in the following examples (and in particular seen in the SEM images in the figures) is about 2-5 nm. Smaller strut widths, such as these, permit a greater amount of struts to be present within the network and thus contact the electrochemically active species, in turn allowing more of the electrochemically active species to be present within the composite. This increases electrical conductivity and mechanical strength.

Within the context of the present disclosure, the term “fibrillar morphology” and “nanofibrillar morphology” refer to the structural morphology of a nanoporous carbon (e.g., aerogel) being inclusive of struts, rods, fibers, or filaments. For example, in an embodiment, choice of solvent, such as dimethylacetamide (DMAC), can affect the production of such morphology. Further, in certain embodiments, when the carbon aerogel is derived from polyimides, a crystalline polyimide results from the polyimide forming a linear polymer. As will become clearer in the following examples, certain embodiments were observed surprisingly to include a fibrillar morphology as an interconnected polymeric structure, where a long linear structure was anticipated, based on the known behavior of the polyimide precursors. In comparison, the product form of the nanoporous carbon can alternatively be particulate in nature or powder wherein the fibrillar morphology of the carbon aerogel persists. As will become clearer as this specification continues, a fibrillar morphology can provide certain benefits over a particulate morphology, such as mechanical stability/strength and electrical conductivity, particularly when the nanoporous carbon is implemented in specific applications, for example as the anodic material in a LIB. It should be noted that this fibrillar morphology can be found in nanoporous carbons of both a monolithic form and a powder form; in other words, a monolithic carbon can have a fibrillar morphology, and aerogel powder/particles can have a fibrillar morphology. Furthermore, in certain embodiments, when the nanoporous carbon material contains additives, such as silicon or others, the fibrillar nanostructure inherent to the carbon material is preserved and serves as a bridge between additive particles.

In certain embodiments, the current technology is a method of forming or manufacturing a porous carbon material, such as a carbon aerogel. The porous carbon material can be continuous monolithic material or a particulate material, e.g., in the form of beads or a powder. In an exemplary process, polyimide precursors, such as diamine and dianhydride that can each include an aromatic group and/or an aliphatic group, are mixed in a suitable solvent (e.g., polar, aprotic solvent). An imidization gelation catalyst is then added to initiate the mixture for gelation. In alternative embodiments, imidization can be accomplished via thermal imidization, where any suitable temperature and time range is contemplated (e.g., about 100° C.-200° C. for about 20 minutes to about 8 hours, followed by heating at about 300° C.-400° C. for about 20 minutes to about 1 hour). The gelled mixture is then dried to yield a porous polyimide material, where the drying can be performed using subcritical and/or supercritical carbon dioxide. Optionally, the polyimide material can be compressed, preferably uniaxially (e.g., up to 95% strain), to increase density, adjustable up to about 1.5 g/cc based on the amount of compression. In exemplary embodiments, the polyimide silicon composite can be compressed to greater than about 80% strain prior to pyrolyzing the composite. Regardless of whether compression has taken place, the polyimide material is pyrolyzed to yield the porous carbon material, where the resulting material comprises a porosity between about 5%-99%. In certain embodiments, pyrolysis can be performed at a maximum temperature of between about 750° C. and about 1600° C., optionally with graphitization from about 1600° C. up to about 3000° C.

Additional details regarding polyimide gel/aerogel formation can be found in U.S. Patent Publication No. 2020/0269207 of Zafiropoulos et al., U.S. Pat. Nos. 7,074,880 and 7,071,287 to Rhine et al.; U.S. Pat. No. 6,399,669 to Suzuki et al.; U.S. Pat. No. 9,745,198 to Leventis et al.; Leventis et al., Polyimide Aerogels by Ring-Opening Metathesis Polymerization (ROMP), Chem. Mater. 2011, 23, 8, 2250-2261; Leventis et al., Isocyanate-Derived Organic Aerogels: Polyureas, Polyimides, Polyamides, MRS Proceedings, 1306 (2011), Mrsf10-1306-bb03-01. doi:10.1557/op1.2011.90; Chidambareswarapattar et al., One-step room-temperature synthesis of fibrous polyimide aerogels from anhydrides and isocyanates and conversion to isomorphic carbons, J. Mater. Chem., 2010, 20, 9666-9678; Guo et al., Polyimide Aerogels Cross-Linked through Amine Functionalized Polyoligomeric Silsesquioxane, ACS Appl. Mater. Interfaces 2011, 3, 546-552; Nguyen et al., Development of High Temperature, Flexible Polyimide Aerogels, American Chemical Society, proceedings published 2011; Meador et al., Mechanically Strong, Flexible Polyimide Aerogels Cross-Linked with Aromatic Triamine, ACS Appl. Mater. Interfaces, 2012, 4 (2), pp 536-544; Meador et al., Polyimide Aerogels with Amide Cross-Links: A Low Cost Alternative for Mechanically Strong Polymer Aerogels, ACS Appl. Mater. Interfaces 2015, 7, 1240-1249; Pei et al., Preparation and Characterization of Highly Cross-Linked Polyimide Aerogels Based on Polyimide Containing Trimethoxysilane Side Groups, Langmuir 2014, 30, 13375-13383, each of which is incorporated herein by reference in its entirety. Triamines, tetramines, pentamines, hexamines, etc. can also be used instead of or in addition to diamines or a combination thereof in order to optimize the properties of the gel material. Trianhydrides, tetranhydrides, pentanhydrides, hexanhydrides, can also be used instead of or in addition to dianhydrides or a combination thereof in order to optimize the properties of the gel material. A dehydrating agent and a catalyst can be incorporated into the solution to initiate and drive imidization. In some embodiments, a polyimide wet-gel can be formed without the use of organic solvents. Examples of such methods generally include combining at least one multifunctional amine and an amine in a solvent to form a solution, adding a multifunctional anhydride, and adding a dehydrating reagent to the mixture. The order of addition of reagents may vary. In some embodiments, the multifunctional amine is dissolved in a solvent, such as water, in which case the solution formed can be referred to as an aqueous solution, meaning that the solution is substantially free of any organic solvent. The term “substantially free” as used herein in the context of organic solvents means that no organic solvent has been intentionally added, and no organic solvent is present beyond trace amounts.

The solution can include additional co-gelling precursors, as well as filler materials and other additives. Filler materials and other additives may be dispensed in the solution at any point before or during the formation of a gel. Filler materials and other additives may also be incorporated into the gel material after gelation through various techniques known to those in the art. Preferably, the solution comprising the gelling precursors, solvents, catalysts, water, filler materials, and other additives is a homogenous solution, which is capable of effective gel formation under suitable conditions.

Once a solution has been formed and optimized, the gel-forming components in the solution can be transitioned into a gel material. The process of transitioning gel-forming components into a gel material comprises an initial gel formation step wherein the gel solidifies up to the gel point of the gel material. The gel point of a gel material may be viewed as the point where the gelling solution exhibits resistance to flow and/or forms a substantially continuous polymeric framework throughout its volume. A range of gel-forming techniques is known to those in the art. Examples include, but are not limited to: maintaining the mixture in a quiescent state for a sufficient period of time; adjusting the concentration of a catalyst; adjusting the temperature of the solution; directing a form of energy onto the mixture (ultraviolet, visible, infrared, microwave, ultrasound, particle radiation, electromagnetic); or a combination thereof.

The process of forming gel beads from the gel solution can include combining the solution with a medium, e.g., a dispersion medium, that is non-miscible with the solution. For example, silicone oil or mineral oil can be used as the dispersion medium. The gel solution can be added, e.g., by pouring, or otherwise combined with the non-miscible dispersion medium. Agitation, e.g., by mixing, of the combined dispersion medium and gel precursor solution can be used to promote droplet, e.g., bead, formation before or during the process of transitioning gel-forming components into a gel material. For example, the combination of dispersion medium and gel precursor can form an emulsion with the gel precursor solution as the dispersed phase. Exemplary methods of gel bead production can be found in U.S. Patent Application Publication No. 2006/0084707 of Ou et al., which is incorporated herein by reference in its entirety.

Spherical droplets of gel precursor form in the dispersion medium by virtue of the interface tension. The droplets gel and strengthen during the time in the dispersion medium, e.g., silicone oil. Agitation of the mixture is typically used to prevent the droplets from agglomerating. For example, the mixture of gel precursor and dispersion medium can be stirred to prevent the droplets from agglomerating.

Heat or radiation may also be provided to the dispersion medium to induce or enhance gelation of the droplets or strengthen the gel beads so as to make them strong enough to resist collision. The production capacity of gel beads in a given space depends upon the precise control of the gelation process of the droplets.

The process further includes removing the gel beads from the dispersion medium, e.g., the silicone oil. The gel beads are filtered from the dispersion medium and then washed or rinsed with fluids, e.g., alcohols such as ethanol, methanol, isopropanol, or higher alcohols. A basic requirement for the rinsing liquid is that it can remove the oil (or other dispersing medium) while not reacting chemically with the gel. After removal of the excess amount of silicone oil, the gel beads can be placed into a solvent for aging, as discussed in more detail below. For example, the gel beads can be aged in ethanol. The gel beads are amenable to interstitial solvent removal using supercritical fluid drying methods as discussed herein. They may also be dried at ambient conditions to make xerogels. The dried gel beads, e.g., aerogel or xerogel beads, are amenable to heat treatment and carbonization, as discussed in more detail below. In exemplary embodiments, the gel beads are substantially spherical.

As discussed above, prior to gelation, the sol mixture is combined with a medium, e.g., a dispersion medium, such as silicone oil or mineral oil, high or low shear to form gel beads. Exemplary embodiments of mixing to provide gel beads from the sol mixture in a dispersion medium include magnetic stirring (up to about 600 rpm), mechanical mixing (up to about 800 rpm) and homogenization (up to about 9000 rpm). In some embodiments, an additional solvent, e.g., ethanol, can be added to mixture of beads and dispersion medium after gelation to produce smaller beads and reduce agglomeration of large clusters of beads.

The process of transitioning gel-forming components into a gel material can also include an aging step (also referred to as curing) prior to liquid phase extraction. Aging a gel material after it reaches its gel point can further strengthen the gel framework by increasing the number of cross-linkages within the network. The duration of gel aging can be adjusted to control various properties within the resulting aerogel material. This aging procedure can be useful in preventing potential volume loss and shrinkage during liquid phase extraction. Aging can involve: maintaining the gel (prior to extraction) at a quiescent state for an extended period; maintaining the gel at elevated temperatures; adding cross-linkage promoting compounds; or any combination thereof. The preferred temperatures for aging are usually between about 10° C. and about 200° C. The aging of a gel material typically continues up to the liquid phase extraction of the wet-gel material.

The time period for transitioning gel-forming materials into a gel material includes both the duration of the initial gel formation (from initiation of gelation up to the gel point), as well as the duration of any subsequent curing and aging of the gel material prior to liquid phase extraction (from the gel point up to the initiation of liquid phase extraction). The total time period for transitioning gel-forming materials into a gel material is typically between about 1 minute and several days, preferably about 30 hours or less, about 24 hours or less, about 15 hours or less, about 10 hours or less, about 6 hours or less, about 4 hours or less, about 2 hours or less, about 1 hour or less, about 30 minutes or less, or about 15 minutes or less.

The resulting gel material may be washed in a suitable secondary solvent to replace the primary reaction solvent present in the wet-gel. Such secondary solvents may be linear monohydric alcohols with 1 or more aliphatic carbon atoms, dihydric alcohols with 2 or more carbon atoms, branched alcohols, cyclic alcohols, alicyclic alcohols, aromatic alcohols, polyhydric alcohols, ethers, ketones, cyclic ethers or their derivative.

After removal of the gel beads from the dispersion medium, the gel beads can undergo a process of aging and rinsing. In exemplary embodiments, the first step includes rinsing the bead gel with a solvent, e.g., ethanol or a hydrocarbon solvent such as hexane or octane, under a low vacuum filtration. A second step can include aging the bead gel in solvent, e.g., ethanol, for about 24 to 48 hours at a temperature in the range of about 50° C. to 70° C. The aging fluid bath can be changed during the aging period to remove unreacted compounds and substitute the sol-gel solvent, e.g., DMAC, with the aging solvent, e.g., ethanol.

Once a gel material has been formed and processed, the liquid phase of the gel can then be at least partially extracted from the wet-gel using extraction methods, including processing and extraction techniques, to form an aerogel material. Liquid phase extraction, among other factors, plays an important role in engineering the characteristics of aerogels, such as porosity and density, as well as related properties such as thermal conductivity. Generally, aerogels are obtained when a liquid phase is extracted from a gel in a manner that causes low shrinkage to the porous network and framework of the wet gel.

Aerogels are commonly formed by removing the liquid mobile phase from the gel material at a temperature and pressure near or above the critical point of the liquid mobile phase. Once the critical point is reached (near critical) or surpassed (supercritical) (i.e., pressure and temperature of the system is at or higher than the critical pressure and critical temperature respectively) a new supercritical phase appears in the fluid that is distinct from the liquid or vapor phase. The solvent can then be removed without introducing a liquid-vapor interface, capillary pressure, or any associated mass transfer limitations typically associated with liquid-vapor boundaries. Additionally, the supercritical phase is more miscible with organic solvents in general, thus having the capacity for better extraction. Co-solvents and solvent exchanges are also commonly used to optimize the supercritical fluid drying process.

If evaporation or extraction occurs below the supercritical point, capillary forces generated by liquid evaporation can cause shrinkage and pore collapse within the gel material Maintaining the mobile phase near or above the critical pressure and temperature during the solvent extraction process reduces the negative effects of such capillary forces. In certain embodiments of the present disclosure, the use of near-critical conditions just below the critical point of the solvent system may allow production of aerogel materials or compositions with sufficiently low shrinkage, thus producing a commercially viable end-product.

Following the aging step, the gel beads are typically clustered as wet gel agglomerates. These agglomerates are, in exemplary embodiments, dispersed by sonication in a solvent, such as ethanol. For example, a probe sonicator can be used to disperse the agglomerated beads. In certain embodiments, a decanting step can be employed to remove the fine, non-settling beads from the upper part of the bead suspension following sonication. The remaining bead suspension can then be diluted with more ethanol and sonicated again. The steps of sonication, decanting, and dilution can be repeated until most of the gel beads are dispersed. The dispersed beads can then be filtered to yield a wet cake of gel beads. The wet cake of gel beads is then dried according the embodiments disclosed herein.

As discussed herein, wet gels can be dried using various techniques to provide an aerogel material. In exemplary embodiments, gel bead materials can be dried at ambient pressure, at subcritical conditions, or at supercritical conditions.

Both room temperature and high temperature processes can be used to dry beads at ambient pressure. In some embodiments, a slow ambient pressure drying process can be used in which the wet gel beads are spread in a thin layer and exposed to air in an open container for a period of time sufficient to remove solvent from the beads, e.g., for a period of time in the range of 24 to 36 hours. The thickness of the bead layer can be in the range of about 5 mm to about 15 mm. The beads can optionally be stirred or fluffed up manually during the drying process to prevent the beads from fusing together during the drying process.

Fluidized bed methods can also be used for ambient temperature drying of gels. In an exemplary embodiment, a fritted Buchner funnel was secured on top of a filtration flask, the wet cake or gel slurry was placed on the frit, the top of the funnel was covered with a Kimwipe tissue, compressed air hooked to the filtration's flask inlet was admitted through the pores of the frit. The beads are maintained in the fluidized bed until the solvent is removed. The dry powder material can then be collected from the funnel.

In another embodiment, the gel beads are dried by heating. For example, the gel beads can be heated in a convection oven. For another example, the gel beads can be spread in a layer and placed on a hot plate. The hot plate can be at a temperature of about 100° C. and the beads can be heated for a period of time in the range of about 2 to about 5 minutes to evaporate most of the ethanol. After partially drying, the beads can be left at ambient temperature to dry completely for a period of time in the range of about 6 hours to about 12 hours. Without being bound by theory, the volatile solvent can act as a fluidizer or separator as the solvent rapidly leaves the gel bead material, which leads to a reduction in bead agglomeration.

Polyimide gel beads dried at ambient conditions can be referred to as xerogel beads. Exemplary polyimide xerogels having a target density of about 0.05 g/cc have surface areas in the range of about 0.00 m²/g to about 1.5 m²/g, for example in the range of about 0.10 m²/g to about 1.10 m²/g, about 0.10 m²/g to about 1.00 m²/g, about 0.10 m²/g to about 0.50 m²/g, or about 0.10 m²/g to about 0.20 m²/g.

Both supercritical and sub-critical drying can be used to dry beads. In an exemplary embodiment of supercritical drying, the beads are filtered, collected and secured in a porous container having pores smaller than the size of the dried beads, e.g., 5 micron pores. The container having the beads can then be placed into a high-pressure vessel for extraction of solvent with supercritical CO₂. After removal of the solvent, e.g., ethanol, the vessel can be held above the critical point of CO₂ for a period of time, e.g., about 30 minutes. Following supercritical drying, the vessel is depressurized to atmospheric pressure.

In an exemplary embodiment of subcritical drying, the gel beads are dried using liquid CO₂ at a pressure in the range of about 800 psi to about 1200 psi at room temperature. This operation is quicker than supercritical drying, for example, the ethanol can be extracted in about 15 minutes. In the context of this disclosure, beads dried using subcritical drying are referred to as aerogel-like.

Several additional aerogel extraction techniques are known in the art, including a range of different approaches in the use of supercritical fluids in drying aerogels, as well as ambient drying techniques. For example, Kistler (J. Phys. Chem. (1932) 36: 52-64) describes a simple supercritical extraction process where the gel solvent is maintained above its critical pressure and temperature, thereby reducing evaporative capillary forces and maintaining the structural integrity of the gel network. U.S. Pat. No. 4,610,863 describes an extraction process where the gel solvent is exchanged with liquid carbon dioxide and subsequently extracted at conditions where carbon dioxide is in a supercritical state. U.S. Pat. No. 6,670,402 teaches extracting a liquid phase from a gel via rapid solvent exchange by injecting supercritical (rather than liquid) carbon dioxide into an extractor that has been pre-heated and pre-pressurized to substantially supercritical conditions or above, thereby producing aerogels. U.S. Pat. No. 5,962,539 describes a process for obtaining an aerogel from a polymeric material that is in the form a sol-gel in an organic solvent, by exchanging the organic solvent for a fluid having a critical temperature below a temperature of polymer decomposition, and supercritically extracting the fluid/sol-gel. U.S. Pat. No. 6,315,971 discloses a process for producing gel compositions comprising: drying a wet gel comprising gel solids and a drying agent to remove the drying agent under drying conditions sufficient to reduce shrinkage of the gel during drying. U.S. Pat. No. 5,420,168 describes a process whereby Resorcinol/Formaldehyde aerogels can be manufactured using a simple air-drying procedure. U.S. Pat. No. 5,565,142 describes drying techniques in which the gel surface is modified to be stronger and more hydrophobic, such that the gel framework and pores can resist collapse during ambient drying or subcritical extraction. Other examples of extracting a liquid phase from aerogel materials can be found in U.S. Pat. Nos. 5,275,796 and 5,395,805.

One preferred embodiment of extracting a liquid phase from the wet-gel uses supercritical conditions of carbon dioxide, including, for example: first substantially exchanging the primary solvent present in the pore network of the gel with liquid carbon dioxide; and then heating the wet gel (typically in an autoclave) beyond the critical temperature of carbon dioxide (about 31.06° C.) and increasing the pressure of the system to a pressure greater than the critical pressure of carbon dioxide (about 1070 psig). The pressure around the gel material can be slightly fluctuated to facilitate removal of the supercritical carbon dioxide fluid from the gel. Carbon dioxide can be recirculated through the extraction system to facilitate the continual removal of the primary solvent from the wet gel. Finally, the temperature and pressure are slowly returned to ambient conditions to produce a dry aerogel material. Carbon dioxide can also be pre-processed into a supercritical state prior to being injected into an extraction chamber. In other embodiments, extraction can be performed using any suitable mechanism, for example altering the pressures, timings, and solvent discussed above.

In certain embodiments of the present disclosure, a dried polyimide aerogel composition can be subjected to one or more heat treatments for a duration of time of 3 hours or more, between 10 seconds and 3 hours, between 10 seconds and 2 hours, between 10 seconds and 1 hour, between 10 seconds and 45 minutes, between 10 seconds and 30 minutes, between 10 seconds and 15 minutes, between 10 seconds and 5 minutes, between 10 seconds and 1 minute, between 1 minute and 3 hours, between 1 minute and 1 hour, between 1 minute and 45 minutes, between 1 minute and 30 minutes, between 1 minute and 15 minutes, between 1 minute and 5 minutes, between 10 minutes and 3 hours, between 10 minutes and 1 hour, between 10 minutes and 45 minutes, between 10 minutes and 30 minutes, between 10 minutes and 15 minutes, between 30 minutes and 3 hours, between 30 minutes and 1 hour, between 30 minutes and 45 minutes, between 45 minutes and 3 hours, between 45 minutes and 90 minutes, between 45 minutes and 60 minutes, between 1 hour and 3 hours, between 1 hour and 2 hours, between 1 hour and 90 minutes, or in a range between any two of these values.

In certain embodiments, the current technology involves the formation and use of nanoporous carbon-based scaffolds or structures, such as carbon aerogels, as electrode materials within an energy storage device, for example as the primary anodic material in a LIB. The pores of the nanoporous scaffold are designed, organized, and structured to accommodate silicon (or other electrochemically active species, metalloids or metals) and expansion of such materials upon lithiation in a LIB, for example. Alternatively, the pores of the nanoporous scaffold may be filled with sulfide, hydride, any suitable polymer, or other additive where there is benefit to contacting the additive with an electrically conductive material (i.e., the scaffold/aerogel) to provide for a more effective electrode.

To further expand on the exemplary application within LIBs, when nanoporous carbon-based scaffolds, e.g., carbon aerogel materials, are utilized as the primary anodic material as in certain embodiments of the current invention, the nanoporous structure has a narrow pore size distribution, and provides for high electrical conductivity, high mechanical strength, and a morphology and sufficient pore volume (at a final density) to accommodate a high percentage by weight of silicon and expansion thereof. Structurally, certain embodiments of the carbon-based scaffolds of the current technology have a nanoporous structure provided by fibrillar morphology with a strut size that produces the aforementioned narrow pore size distribution, high pore volume, and enhanced connectedness, among other properties.

In additional or alternative embodiments, the carbon aerogel itself functions as a current collector due to its electrical conductivity and mechanical strength, thus, in a preferred embodiment, eliminating the need for a distinct current collector on the anode side (when the anode is formed of the carbon aerogel). It is noted that in conventional LIBs, a copper foil is coupled to the anode as its current collector. However, removal of one or both of these components, depending on the application of the carbon aerogel, derives additional space for more electrode material, resulting in even greater capacity of the cell/individual electrode and overall greater energy density of the packaged battery system. However, in certain embodiments, existing current collectors may be integrated with the anode materials of various other embodiments to augment the copper or aluminum foils' current collection capabilities or capacities.

In certain embodiments, nanoporous carbon-based scaffolds or structures, and specifically the carbon aerogel can be used as the conductive network or current collector on the anode side of an energy storage device. The fully interconnected carbon aerogel network is filled with electrochemically active species, where the electrochemically active species are in direct contact or physically connected to the carbon network. Loading of electrochemically active species is tuned with respect to pore volume and porosity for high and stable capacity and improved energy storage device safety. When utilized on the anode side, the electrochemically active species may include, for example, silicon, graphite, lithium or other metalloids or metals. In yet another embodiment, the anode may comprise nanoporous carbon-based scaffolds or structures, and specifically carbon aerogels.

Within the context of the present disclosure, the term “collector-less” refers to the absence of a distinct current collector that is directly connected to an electrode. As noted, in conventional LIBs, a copper foil is typically coupled to the anode as its current collector. Electrodes formed from nanoporous carbon-based scaffolds or structures (e.g., carbon aerogels), according to embodiments of the current invention, can be a freestanding structure or otherwise have the capability of being collector-less since the scaffold or structure itself functions as the current collector, due to its high electrical conductivity. Within the electrochemical cell, a collector-less electrode can be connected to form a circuit by embedding solid, mesh, woven tabs during the solution step of making the continuous porous carbon; or by soldering, welding, or metal depositing leads onto a portion of the porous carbon surface. Other mechanisms of contacting the carbon to the remainder of the system are contemplated herein as well. In alternative embodiments, the nanoporous carbon-based scaffolds or structures, and specifically a carbon aerogel may be disposed on or otherwise in communication with a dedicated current-collecting substrate (e.g., copper foil, aluminum foil, etc.). In this scenario, the carbon aerogel can be attached to a solid current collector using a conductive adhesive and applied with varying amounts of pressure.

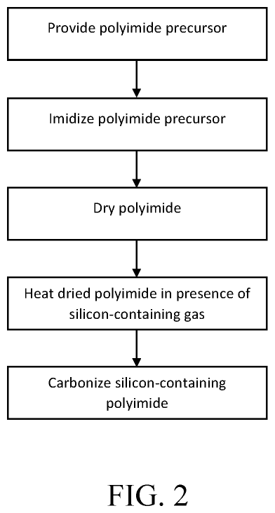

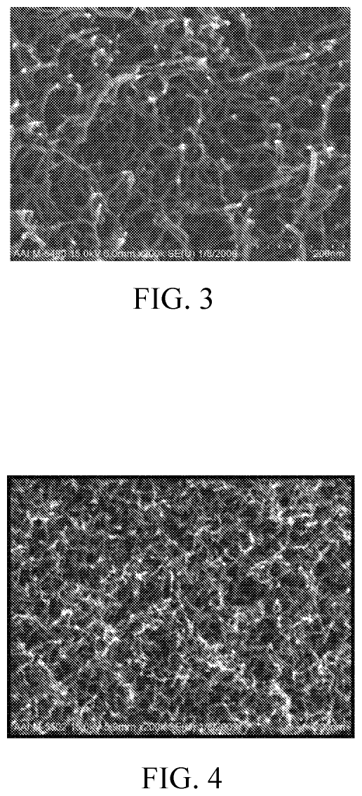

Furthermore, it is contemplated herein that the nanoporous carbon-based scaffolds or structures, and specifically carbon aerogels, can take the form of monolithic structures. When monolithic in nature, the carbon aerogel eliminates the need for any binders; in other words, the anode can be binder-less. As used herein, the term “monolithic” refers to aerogel materials in which a majority (by weight) of the aerogel included in the aerogel material or composition is in the form of a unitary, continuous, interconnected aerogel nanostructure. Monolithic aerogel materials include aerogel materials which are initially formed to have a unitary interconnected gel or aerogel nanostructure, but which can be subsequently cracked, fractured or segmented into non-unitary aerogel nanostructures. Monolithic aerogels may take the form of a freestanding structure or a reinforced (fiber or foam) material. In comparison, using silicon lithiation as an example, silicon incorporated into a monolithic aerogel can be utilized more effectively relative to theoretical capacity, as compared to the same amount of silicon incorporated into a slurry using conventional processes (see FIG. 2).

Monolithic aerogel materials are differentiated from particulate aerogel materials. The term “particulate aerogel material” refers to aerogel materials in which a majority (by weight) of the aerogel included in the aerogel material is in the form of particulates, particles, granules, beads, or powders, which can be combined together (i.e., via a binder, such as a polymer binder) or compressed together but which lack an interconnected aerogel nanostructure between individual particles. Collectively, aerogel materials of this form will be referred to as having a powder or particulate form (as opposed to a monolithic form). It should be noted that despite an individual particle of a powder having a unitary structure, the individual particle is not considered herein as a monolith. Integration of aerogel powder into an electrochemical cell typically preparation of a paste or slurry from the powder, casting and drying onto a substrate, and may optionally include calendaring.

Particulate aerogel materials, e.g., aerogel beads, provide certain advantages. For example, particulate materials according to embodiments disclosed herein can be used as a direct replacement for other materials such as graphite in LIB anodes and anode manufacturing processes. Particulate materials according to embodiments disclosed herein can also provide improved lithium ion diffusion rates due to shorter diffusion paths within the particulate material. Particulate materials according to embodiments disclosed herein can also allow for electrodes with optimized packing densities, e.g., by tuning the particle size and packing arrangement. Particulate materials according to embodiments disclosed herein can also provide improved access to silicon due to inter-particle and intra-particle porosity.

Within the context of the present disclosure, the terms “binder-less” or “binder-free” (or derivatives thereof) refer to a material being substantially free of binders or adhesives to hold that material together. For example, a monolithic nanoporous carbon material is free of binder since its framework is formed as a unitary, continuous interconnected structure. Advantages of being binder-less include avoiding any effects of binders, such as on electrical conductivity and pore volume. On the other hand, aerogel particles require a binder to hold together to form a larger, functional material; such larger material is not contemplated herein to be a monolith. In addition, this “binder-free” terminology does not exclude all uses of binders. For example, a monolithic aerogel, according to the current invention, may be secured to another monolithic aerogel or a non-aerogel material by disposing a binder or adhesive onto a major surface of the aerogel material. In this way, the binder is used to create a laminate composite, but the binder has no function to maintain the stability of the monolithic aerogel framework itself.

Furthermore, monolithic polymeric aerogel materials or compositions of the present disclosure may be compressed up to 95% strain without significant breaking or fracturing of the aerogel framework, while densifying the aerogel and minimally reducing porosity. In certain embodiments, the compressed polymeric aerogel materials or compositions are subsequently carbonized using varying methods described herein, to form nanoporous carbon materials. It can be understood that amount of compression affects thickness of the resulting carbon material, where the thickness has an effect on capacity, as will become clearer as this specification continues. The examples, described infra, will illustrate varying thicknesses that are formed and contemplated by the current invention, where thickness is adjustable based on compression. As such, thickness of a composite (typically compressed) can be about 10-1000 micrometers, or any narrower range therein based on benefits needed of the final composite. The current invention also contemplates a powder or particle form of the carbon aerogel, where a binder would be needed and particle size optimized. A range of particle sizes may be about 1-50 micrometers.

Nanoporous carbons, such as carbon aerogels, according to the current invention, can be formed from any suitable organic precursor materials. Examples of such materials include, but are not limited to, RF, PF, PI, polyamides, polyacrylate, polymethyl methacrylate, acrylate oligomers, polyoxyalkylene, polyurethane, polyphenol, polybutadiane, trialkoxysilyl-terminated polydimethylsiloxane, polystyrene, polyacrylonitrile, polyfurfural, melamine-formaldehyde, cresol formaldehyde, phenol-furfural, polyether, polyol, polyisocyanate, polyhydroxybenze, polyvinyl alcohol dialdehyde, polycyanurates, polyacrylamides, various epoxies, agar, agarose, chitosan, and combinations and derivatives thereof. Any precursors of these materials may be used to create and use the resulting materials. For example, nanoporous carbons, such as carbon aerogels, can be formed from synthetic polymers or from biopolymer precursor materials. Synthetic polymers useful for producing carbon aerogels include phenolic resins, polymers formed from isocyanates or amines (e.g., the polyimide compositions discussed in more detail herein), polyolefins, and conducting polymers. Phenolic resins suitable for producing carbon aerogels include phenol-formaldehyde (PF), resorcinol-formaldehyde (RF), polyurea-crosslinked RF, pholoroglucinol-formaldehyde (FPOL), cresol-formaldehyde, phenol-furfural, resorcinol-furfural, phloroglucinol-furfural (PF), phloroglucinol-terephthalaldehyde (TPOL), polybenzoxazines (PBO), and melamine-formaldehyde (MF). Isocyanates and amines suitable for producing carbon aerogels can include polyurethane (PU), polyurea (PUA), polyimide (PI), and polyamides (PA). Polyolefins suitable for producing carbon aerogels include polydicyclopentadiene (PDCPD) and polyacrylonitrile (PAN). Conducting polymers suitable for producing carbon aerogels include polypyrrole (PPY). Benzimidazole can also be used to produce carbon aerogels. Biopolymers, such as polysaccharides and proteins, can also be used to produce carbon aerogels. For example, suitable polysaccharides useful for producing carbon aerogels include cellulose, chitin, chitosan, starch, pectin, alginate. Carbon aerogels can also be produced from carbon allotropes such as carbon nanotubes (CNT) or graphene.

In an exemplary embodiment, the carbon aerogel is formed from a pyrolyzed/carbonized polyimide-based aerogel, i.e., the polymerization of polyimide. Even more specifically, the polyimide-based aerogel can be produced using one or more methodologies described in U.S. Pat. Nos. 7,071,287 and 7,074,880 to Rhine et al., e.g., by imidization of poly(amic) acid and drying the resulting gel using a supercritical fluid. Other adequate methods of producing polyimide aerogels (and carbon aerogels derived therefrom) are contemplated herein as well, for example as described in U.S. Pat. No. 6,399,669 to Suzuki et al.; U.S. Pat. No. 9,745,198 to Leventis et al.; Leventis et al., Polyimide Aerogels by Ring-Opening Metathesis Polymerization (ROMP), Chem. Mater. 2011, 23, 8, 2250-2261; Leventis et al., Isocyanate-Derived Organic Aerogels: Polyureas, Polyimides, Polyamides, MRS Proceedings, 1306 (2011), Mrsf10-1306-bb 03-01. doi: 10.1557/op1.2011.90; Chidambareswarapattar et al., One-step room-temperature synthesis of fibrous polyimide aerogels from anhydrides and isocyanates and conversion to isomorphic carbons, J. Mater. Chem., 2010, 20, 9666-9678; Guo et al., Polyimide Aerogels Cross-Linked through Amine Functionalized Polyoligomeric Silsesquioxane, ACS Appl. Mater. Interfaces 2011, 3, 546-552; Nguyen et al., Development of High Temperature, Flexible Polyimide Aerogels, American Chemical Society, proceedings published 2011; Meador et al., Mechanically Strong, Flexible Polyimide Aerogels Cross-Linked with Aromatic Triamine, ACS Appl. Mater. Interfaces, 2012, 4 (2), pp 536-544; Meador et al., Polyimide Aerogels with Amide Cross-Links: A Low Cost Alternative for Mechanically Strong Polymer Aerogels, ACS Appl. Mater. Interfaces 2015, 7, 1240-1249; Pei et al., Preparation and Characterization of Highly Cross-Linked Polyimide Aerogels Based on Polyimide Containing Trimethoxysilane Side Groups, Langmuir 2014, 30, 13375-13383. The resulting polyimide aerogel would then be pyrolyzed to form a polyimide-derived carbon aerogel.

Carbon aerogels according to exemplary embodiments of the present disclosure, e.g., polyimide-derived carbon aerogels, can have a residual nitrogen content of at least about 4 wt %. For example, carbon aerogels according to embodiments disclosed herein can have a residual nitrogen content of at least about 0.1 wt %, at least about 0.5 wt %, at least about 1 wt % at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, or in a range between any two of these values.

In certain embodiments of the present disclosure, a dried polymeric aerogel composition, e.g., bead compositions, can be subjected to a treatment temperature of 200° C. or above, 400° C. or above, 600° C. or above, 800° C. or above, 1000° C. or above, 1200° C. or above, 1400° C. or above, 1600° C. or above, 1800° C. or above, 2000° C. or above, 2200° C. or above, 2400° C. or above, 2600° C. or above, 2800° C. or above, or in a range between any two of these values, for carbonization of the organic (e.g., polyimide) aerogel. Without being bound by theory, it is contemplated herein that the electrical conductivity of the aerogel composition increases with carbonization temperature.

In certain embodiments of the present disclosure, a carbon aerogel composition, e.g., particulate carbon bead composition, can have a particle size of about 1 micrometer, about 2 micrometers, about 3 micrometers, about 4 micrometers, about 5 micrometers, about 6 micrometers, about 7 micrometers, about 8 micrometers, about 9 micrometers, about 10 micrometers, about 15 micrometers, about 20 micrometers, about 25 micrometers, about 30 micrometers, about 35 micrometers, about 40 micrometers, about 45 micrometers, about 50 micrometers, or in a range between any two of these values. In exemplary embodiments, a carbon aerogel composition, e.g., particulate carbon bead composition, can have a particle size in the range of about 5 micrometers to about 10 micrometers.

Within the context of the present disclosure, the term “electrical conductivity” refers to a measurement of the ability of a material to conduct an electric current or other allow the flow of electrons therethrough or therein. Electrical conductivity is specifically measured as the electric conductance/susceptance/admittance of a material per unit size of the material. It is typically recorded as S/m (Siemens/meter) or S/cm (Seimens/centimeter). The electrical conductivity or resistivity of a material may be determined by methods known in the art, for example including, but not limited to: In-line Four Point Resistivity (using the Dual Configuration test method of ASTM F84-99). Within the context of the present disclosure, measurements of electrical conductivity are acquired according to ASTM F84-resistivity (R) measurements obtained by measuring voltage (V) divided by current (I), unless otherwise stated. In certain embodiments, aerogel materials or compositions of the present disclosure have an electrical conductivity of about 10 S/cm or more, 20 S/cm or more, 30 S/cm or more, 40 S/cm or more, 50 S/cm or more, 60 S/cm or more, 70 S/cm or more, 80 S/cm or more, or in a range between any two of these values.

In exemplary embodiments, silicon (or other electrochemically active species) is created, infiltrated, deposited, or otherwise formed within the pores of the scaffold materials provided herein. In some embodiments, electrochemical modifiers, e.g., silicon, can be created within the pores of a carbon-based scaffold material such as a carbon aerogel or xerogel. In some embodiments, electrochemical modifiers, e.g., silicon, can be created within the pores of a precursor material to carbon-based scaffold materials such as cellulose-based, polysaccharide-based, resin-based (e.g., RF), polyimide-based, polyurea-based, polyurethane-based, or poly(vinyl alcohol)-based aerogels or aerogel-like materials. Various examples of aerogels and carbon aerogels are discussed in Zuo, Lizeng et al. “Polymer/Carbon-Based Hybrid Aerogels: Preparation, Properties and Applications.” Materials (Basel, Switzerland) vol. 8,10 6806-6848. 9 Oct. 2015, which is incorporated herein by reference in its entirety.

Without being bound by theory, it is believed the fibrillar morphology of the nanoporous structures provided herein can provide certain benefits over particulate morphologies or conventional porous morphologies, such as providing mechanical stability/strength, electrical conductivity, surface area, and pore structures, each of which, alone or in combination can enhance the properties of the resulting carbon-silicon composites. For example, the fibrillar morphology of the nanoporous structures provided herein is particularly beneficial for methods in which silicon is (or other electrochemically active species) is created, infiltrated, deposited, or otherwise formed within the pores of the scaffold materials provided herein.

In exemplary embodiments, silicon (or other electrochemically active species) is created within pores of the nanoporous carbon-based scaffold materials (or precursor materials to nanoporous carbon-based scaffold materials) by subjecting the materials to elevated temperature and the presence of a silicon-containing gas, preferably silane, in order to achieve silicon deposition/infiltration via processes such as chemical vapor deposition (CVD) or chemical vapor infiltration (CVI). In some embodiments, silicon and other electrochemically active species can be co-deposited or co-infiltrated simultaneously or, alternatively, sequentially. For example, silicon and tin may be deposited or infiltrated into the scaffold materials simultaneously or, alternatively, sequentially. For another example, silicon and germanium or silicon and germanium alloys may be deposited or infiltrated into the scaffold materials simultaneously or, alternatively, sequentially. For other examples, other silicon metal composites may be co-deposited or co-infiltrated simultaneously or, alternatively, sequentially into the scaffold materials.

The silane gas can be mixed with other inert gases, for example, nitrogen gas. The temperature and time of processing can be varied, for example the temperature can be between 300 and 400° C., for example between 400 and 500° C., for example between 500 and 600° C., for example between 600 and 700° C., for example between 700 and 800° C., for example between 800 and 900° C. The mixture of gas can comprise between 0.1 and 1% silane and remainder inert gas. Alternatively, the mixture of gas can comprise between 1% and 10% silane and remainder inert gas. Alternatively, the mixture of gas can comprise between 10% and 20% silane and remainder inert gas. Alternatively, the mixture of gas can comprise between 20% and 50% silane and remainder inert gas. Alternatively, the mixture of gas can comprise above 50% silane and remainder inert gas. Alternatively, the gas can essentially be 100% silane gas. The reactor in which the CVD process is carried out is according to various designs as known in the art, for example in a fluid bed reactor, a static bed reactor, an elevator kiln, a rotary kiln, a box kiln, or other suitable reactor type. The reactor materials are suitable for this task, as known in the art. In a preferred embodiment, the nanoporous carbon-based scaffold materials are processed under condition that provide uniform access to the gas phase, for example a reactor wherein particles of the nanoporous carbon-based scaffold materials are fluidized, or otherwise agitated to provide said uniform gas access.

In some embodiments, the CVD process is a plasma-enhanced chemical vapor deposition (PECVD) process. This process is known in the art to provide utility for depositing thin films from a gas state (vapor) to a solid state on a substrate. Chemical reactions are involved in the process, which occur after creation of a plasma of the reacting gases. The plasma is generally created by RF (AC) frequency or DC discharge between two electrodes, the space between which is filled with the reacting gases. In certain embodiments, the PECVD process is utilized for porous carbon that is coated on a substrate suitable for the purpose, for example a copper foil substrate. The PECVD can be carried out at various temperatures, for example between 300 and 800° C., for example between 300 and 600° C., for example between 300 and 500° C., for example between 300 and 400° C., for example at 350° C. The power can be varied, for example 25W RF, and the silane gas flow required for processing can be varied, and the processing time can be varied as known in the art.

The silicon (or other electrochemically active species) that is impregnated into the nanoporous carbon-based scaffold materials (or precursor materials to nanoporous carbon-based scaffold materials), regardless of the process, is envisioned to have certain properties that are optimal for utility as an energy storage material. For example, the size and shape of the silicon (or other electrochemically active species) can be varied accordingly to match, while not being bound by theory, the extent and nature of the pore volume within the nanoporous carbon-based scaffold material. For example, the silicon can be impregnated, deposited by CVD, CVI, or other appropriate process, into pores within the nanoporous carbon-based scaffold materials or precursors thereof having a narrow pore size distribution, i.e., materials comprising a pore size distribution (full width at half max) of about 50 nm or less, 45 nm or less, 40 nm or less, 35 nm or less, 30 nm or less, 25 nm or less, 20 nm or less, 15 nm or less, 10 nm or less, 5 nm or less, or in a range between any two of these values. In some embodiments, the silicon can be impregnated, deposited by CVD, CVI, or other appropriate process, into pores within the nanoporous carbon-based scaffold materials or precursors thereof having a narrow pore size distribution, i.e., materials having a ratio of the pore size of a predominant peak in a pore size distribution chart to the full width at half max of about 2:1. For example, nanoporous carbon-based scaffold materials or precursors thereof having a predominant peak in a pore size distribution chart in the range of about 2 nanometers to about 50 nanometers and a full width at half max in the range of about 25 nm to about 1 nm. Other ranges of pores sizes with regards to fractional pore volume, whether micropores, mesopores, or macropores, are also envisioned as described elsewhere within this disclosure.

The oxygen content in silicon can be less than 50%, for example, less than 30%, for example less than 20%, for example less than 15%, for example, less than 10%, for example, less than 5%, for example, less than 1%, for example less than 0.1%. In certain embodiments, the oxygen content in the silicon is between 1 and 30%. In certain embodiments, the oxygen content in the silicon is between 1 and 20%. In certain embodiments, the oxygen content in the silicon is between 1 and 10%. In certain embodiments, the oxygen content in the porous silicon materials is between 5 and 10%.

In certain embodiments wherein the silicon contains oxygen, the oxygen is incorporated such that the silicon exists as a mixture of silicon and silicon oxides of the general formula SiOx, where X is a non-integer (real number) can vary continuously from 0.01 to 2. In certain embodiments, the fraction of oxygen present on the surface of the nano-feature porous silicon is higher compared to the interior of the particle.

In certain embodiments, the silicon comprises crystalline silicon. In certain embodiments, the silicon comprises polycrystalline silicon. In certain embodiments, the silicon comprises micro-polycrystalline silicon. In certain embodiments, the silicon comprises nano-polycrystalline silicon. In certain other embodiments, the silicon comprises amorphous silicon.

CVD/CVI is generally accomplished by subjecting the nanoporous carbon-based scaffold materials or precursors thereof to an elevated temperature for a period of time in the presence of a suitable deposition gas containing carbon atoms. Suitable gases in this context include, but are not limited to methane, propane, butane, cyclohexane, ethane, propylene, and acetylene. The temperature can be varied, for example between 350 to 1050° C., for example between 350 and 450° C., for example between 450 and 550° C., for example between 550 and 650° C., for example between 650 and 750° C., for example between 750 and 850° C., for example between 850 and 950° C., for example between 950 and 1050° C. The deposition time can be varied, for example between 0 and 5 min, for example between 5 and 15 min, for example between 15 and 30 min, for example between 30 and 60 min, for example between 60 and 120 min, for example between 120 and 240 min. In some embodiments, the deposition time is greater than 240 min. In certain embodiments, the deposition gas is methane and the deposition temperature is greater than or equal to 950° C. In certain embodiments, the deposition gas is propane and the deposition temperature is less than or equal to 750° C. In certain embodiments, the deposition gas is cyclohexane and the deposition temperature is greater than or equal to 800° C.

In certain embodiments, the reactor itself can be agitated, in order to agitate the particles of nanoporous carbon-based scaffold materials to be silicon impregnated. For example, the impregnation process can be carried out in a static mode, wherein the particles are not agitated, and the silicon-containing reactant flows over, around, or otherwise comes in contact with the particles to be coated. In other exemplary modes, the particles can be fluidized, for example the impregnation with silicon-containing reactant can be carried out in a fluidized bed reactor. A variety of different reactor designs can be employed in this context as known in the art, including, but not limited to, elevator kiln, roller hearth kiln, rotary kiln, box kiln, and modified fluidized bed designs. Any extra or scrap silicon generated from the processes disclosed herein, i.e., silicon that is not deposited within the nanoporous carbon-based scaffold materials, can be isolated and re-used as an input material.

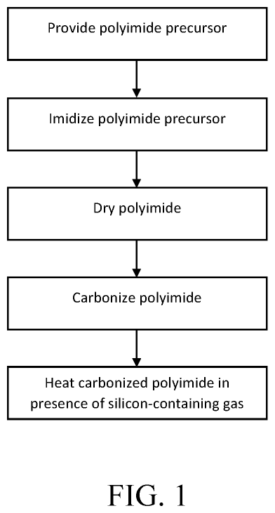

Accordingly, the present disclosure provides for the manufacturing of a composite carbon-silicon material, wherein the carbon scaffold material is a nanoporous carbon-based scaffold material, and wherein the silicon impregnation is achieved by contacting the nanoporous carbon-based scaffold material with a silicon-containing reactant. FIG. 1 illustrates an example of such a method. For example, the process may involve the following steps:
a) providing a mixture of a polymer precursor materials,
b) initiating imidization of the mixture chemically or thermally,
c) drying the imidized mixture to yield a porous polymer material,
d) carbonizing the porous polymer material to create a nanoporous carbon-based scaffold material
e) subjecting the nanoporous carbon-based scaffold material to elevated temperature in the presence of a silicon-containing reactant within a static or agitated reactor, resulting in a silicon-impregnated carbon material.

In another embodiment, the present disclosure provides for the manufacturing of a composite carbon-silicon material, wherein the carbon scaffold material is a nanoporous carbon-based scaffold material, and wherein the silicon impregnation is achieved by contacting with a silicon-containing reactant, and wherein a terminal carbon coating is achieved by contacting the composite with a carbon-containing reactant. For example, the process may involve the following steps:
a) providing a mixture of a polymer precursor materials,
b) initiating imidization of the mixture chemically or thermally,
c) drying the imidized mixture to yield a porous polymer material,
d) carbonizing the porous polymer material to create a nanoporous carbon-based scaffold material,
e) subjecting the nanoporous carbon-based scaffold material to elevated temperature in the presence of a silicon-containing reactant within a static or agitated reactor, resulting in a silicon-impregnated carbon material,
f) subjecting the silicon impregnated carbon material to elevated temperature in the presence of a carbon-containing reactant within a static or agitated reactor, resulting in a terminally carbon coated carbon-silicon composite material.

In another embodiment, the present disclosure provides for the manufacturing of a composite carbon-silicon material, wherein the carbon scaffold material is a nanoporous carbon-based scaffold material, and wherein the silicon impregnation is achieved by contacting with a silicon-containing reactant, and wherein a terminal conducting polymer coating is achieved by contacting the composite with a conductive polymer, and optionally pyrolyzing the material. For example, the process may involve the following steps:
a) providing a mixture of a polymer precursor materials,
b) initiating imidization of the mixture chemically or thermally,
c) drying the imidized mixture to yield a porous polymer material,
d) carbonizing the porous polymer material to create a nanoporous carbon-based scaffold material,
e) subjecting the nanoporous carbon-based scaffold material to elevated temperature in the presence of a silicon-containing reactant within a static or agitated reactor, resulting in a silicon-impregnated carbon material,
f) subjecting the silicon impregnated carbon material to elevated temperature in the presence of a conductive polymer within a static or agitated reactor, resulting in a terminally carbon coated carbon-silicon composite material,
g) the materials of (f) can be optionally pyrolyzed.

The silicon-impregnated porous carbon composite material can also be terminally carbon coated via a hydrothermal carbonization wherein the particles are processed by various modes according to the art. Hydrothermal carbonization can be accomplished in an aqueous environment at elevated temperature and pressure to obtain a carbon-silicon composite. Examples of temperature to accomplish the hydrothermal carbonization vary, for example between 150° C. and 300° C., for example, between 170° C. and 270° C., for example between 180° C. and 260° C., for example, between 200 and 250° C. Alternatively, the hydrothermal carbonization can be carried out at higher temperatures, for example, between 200 and 800° C., for example, between 300 and 700° C., for example between 400 and 600° C. In some embodiments, the hydrothermal carbonization can be carried out at a temperature and pressure to achieve graphitic structures. The range of pressures suitable for conducting the hydrothermal carbonization are known in the art, and the pressure can vary, for example, increase, over the course of the reaction. The pressure for hydrothermal carbonization can vary from 0.1 MPa to 200 MPA. In certain embodiments the pressure of hydrothermal carbonization is between 0.5 MPa and 5 MPa. In other embodiments, the pressure of hydrothermal carbonization is between 1 MPa and 10 MPa, or between 5 and 20 MPa. In yet other embodiments, the pressure of hydrothermal carbonization is between 10 MPa and 50 MPa. In yet other embodiments, the pressure of hydrothermal carbonization is between 50 MPa and 150 MPa. In yet other embodiments, the pressure of hydrothermal carbonization is between 100 MPa and 200 MPa. Feedstock suitable as carbon source for hydrothermal carbonization are also known in the art. Such feedstocks for hydrothermal carbonization typically comprise carbon and oxygen, these include, but are not limited to, sugars, oils, biowastes, polymers, and polymer precursors described elsewhere within this disclosure.

Accordingly, the present disclosure provides for the manufacturing of a composite carbon-silicon material, wherein the carbon scaffold material is a nanoporous carbon-based scaffold material, and wherein the silicon impregnation is achieved by contacting with a silicon-containing reactant, and wherein a terminal carbon coating is achieved by hydrothermal carbonization. For example, the process may involve the following steps:
a) providing a mixture of a polymer precursor materials,
b) initiating imidization of the mixture chemically or thermally,
c) drying the imidized mixture to yield a porous polymer material,
d) carbonizing the porous polymer material to create a nanoporous carbon-based scaffold material,
e) subjecting the nanoporous carbon-based scaffold material to elevated temperature in the presence of a silicon-containing reactant within a static or agitated reactor, resulting in a silicon-impregnated carbon material
f) subjecting the silicon impregnated carbon material to hydrothermal carbonization to yield a composite comprising the silicon impregnated carbon materials terminally carbon coated via hydrothermal carbonization.

In another embodiment, the present disclosure provides for the manufacturing of a composite carbon-silicon material, wherein the carbon scaffold material is a nanoporous carbon-based scaffold material, and wherein the silicon impregnation is achieved by contacting a precursor porous polymer material of the nanoporous carbon-based scaffold material with a silicon-containing reactant before carbonization of the precursor porous polymer material. FIG. 2 illustrates an example of such a method. For example, the process may involve the following steps:
a) providing a mixture of a polymer precursor materials,
b) initiating imidization of the mixture chemically or thermally,
c) drying the imidized mixture to yield a porous polymer material,
d) subjecting the porous polymer material to elevated temperature in the presence of a silicon-containing reactant within a static or agitated reactor, resulting in a silicon-impregnated porous polymer material,
e) carbonizing the silicon-impregnated porous polymer material to create a silicon impregnated carbon material.

In another embodiment, the present disclosure provides for the manufacturing of a composite carbon-silicon material, wherein the carbon scaffold material is a nanoporous carbon-based scaffold material, and wherein the silicon impregnation and carbonization are simultaneously achieved by contacting a precursor porous polymer material of the nanoporous carbon-based scaffold material with a silicon-containing reactant during carbonization of the precursor porous polymer material. For example, the process may involve the following steps:
a) providing a mixture of a polymer precursor materials,
b) initiating imidization of the mixture chemically or thermally,
c) drying the imidized mixture to yield a porous polymer material,
d) subjecting the porous polymer material to elevated temperature sufficient to carbonize the porous polymer material in the presence of a silicon-containing reactant within a static or agitated reactor, resulting in a silicon-impregnated carbon material.

In another embodiment, the present disclosure provides for the manufacturing of a composite carbon-silicon material, wherein the carbon scaffold material is a nanoporous carbon-based scaffold material, and wherein the silicon impregnation is achieved by contacting a precursor porous polymer material of the nanoporous carbon-based scaffold material with a silicon-containing reactant before carbonization of the precursor porous polymer material, and

wherein a terminal carbon coating is achieved by contacting the composite with a carbon-containing reactant. For example, the process may involve the following steps:
a) providing a mixture of a polymer precursor materials,
b) initiating imidization of the mixture chemically or thermally,
c) drying the imidized mixture to yield a porous polymer material,
d) subjecting the porous polymer material to elevated temperature in the presence of a silicon-containing reactant within a static or agitated reactor, resulting in a silicon-impregnated porous polymer material,
e) carbonizing the silicon-impregnated porous polymer material to create a silicon impregnated carbon material,
f) subjecting the silicon impregnated carbon material to elevated temperature in the presence of a carbon-containing reactant within a static or agitated reactor, resulting in a terminally carbon coated carbon-silicon composite material.

In another embodiment, the present disclosure provides for the manufacturing of a composite carbon-silicon material, wherein the carbon scaffold material is a nanoporous carbon-based scaffold material, and wherein the silicon impregnation is achieved by contacting a precursor porous polymer material of the nanoporous carbon-based scaffold material with a silicon-containing reactant before carbonization of the precursor porous polymer material, and wherein a terminal conducting polymer coating is achieved by contacting the composite with a conductive polymer, and optionally pyrolyzing the material. For example, the process may involve the following steps:
a) providing a mixture of a polymer precursor materials,
b) initiating imidization of the mixture chemically or thermally,
c) drying the imidized mixture to yield a porous polymer material,
d) subjecting the porous polymer material to elevated temperature in the presence of a silicon-containing reactant within a static or agitated reactor, resulting in a silicon-impregnated porous polymer material,
e) carbonizing the silicon-impregnated porous polymer material to create a silicon impregnated carbon material,
f) subjecting the silicon impregnated carbon material to elevated temperature in the presence of a carbon-containing reactant within a static or agitated reactor, resulting in a terminally carbon coated carbon-silicon composite material
g) e) the materials of (d) can be optionally pyrolyzed.

Without being bound by theory, it is important that surface of the carbon particle need to achieve the desired temperature to achieve the desired extent of reaction and deposition with the silicon-containing gas. Conventional engineering principles dictate that it is difficult to heat the interior vs the exterior of the particle, for example the particle heats from the outside surface via convective heating (or perhaps other mechanism such as, but not limited to, microwaves or radiative heating), and then the temperature within the particle heats via conductive heating from the outside of the carbon particle to the inside. It is non-obvious that in the case of a porous particle, the inside of the particle heats concomitantly with the outside, provided that the inside comprises surface area with equal access to the gas molecules that are colliding with the carbon on the particle surface and imparting heat via convection.

Without being bound by theory, the reaction condition may be such that the mean free path length of the silicon-containing gas is similar or lower than the diameter and/or the depths of pores that are desired to be filled. Such a case is known in the art as controlled by Knudsen diffusion, i.e., a means of diffusion that occurs when the scale length of a system is comparable to or smaller than the mean free path of the particles involved. Consider the diffusion of gas molecules through very small capillary pores. If the pore diameter is smaller than the mean free path of the diffusing gas molecules and the density of the gas is low, the gas molecules collide with the pore walls more frequently than with each other. This process is known as Knudsen flow or Knudsen diffusion. The Knudsen number is a good measure of the relative importance of Knudsen diffusion. A Knudsen number much greater than one indicates Knudsen diffusion is important. In practice, Knudsen diffusion applies only to gases because the mean free path for molecules in the liquid state is very small, typically near the diameter of the molecule itself. In cases where the pore diameter is much greater than the mean free path length of the gas, the diffusion is characterized as Fisk diffusion.

The process can be varied for the deposition process, for example can be ambient, or about 101 kPa. In certain embodiments, the pressure can be less than ambient, for example less than 101 kPa, for example less than 10.1 kPa, for example less than 1.01 kPa. In certain embodiments, the gas comprises a mixture of the silicon-containing deposition gas and an inert gas, for example a combination of silane and nitrogen. In this case the partial pressure of the deposition gas can be less than 101 kPa, for example less than 10.1 kPa, for example less than 1.01 kPa. In certain embodiments, the pressure and temperature are such that the silicon-containing gas is supercritical.

Accordingly, in certain embodiments, the silicon-containing reactant can be supercritical silane, for example silane at a temperature above about 270 K (−3 C) and a pressure above about 45 bar. In further embodiments, the silicon-containing reactant can be supercritical silane, for example silane at a temperature between 0-100° C. and a pressure between 45 and 100 bar. In further embodiments, the silicon-containing reactant can be supercritical silane, for example silane at a temperature between 100-600° C. and a pressure between 45 and 100 bar. In further embodiments, the silicon-containing reactant can be supercritical silane, for example silane at a temperature between 300-500° C. and a pressure between 50 and 100 bar. In further embodiments, the silicon-containing reactant can be supercritical silane, for example silane at a temperature between 400-550° C. and a pressure between 50 and 80 bar.

In certain embodiments, the pressure and temperature are both varied over the time within the process of silicon impregnation of the nanoporous carbon-based scaffold. For example, the nanoporous carbon-based scaffold can be held at a certain temperature and pressure, for example at temperature at or higher than ambient, and at a pressure less than ambient. In this case, the combination of low pressure and high temperature allows for desorption of volatile components that could potential clog or otherwise occupy the pores within the nanoporous carbon-based scaffold, thus facilitating the access of the silicon-containing reactant. Examples of temperature pressure conditions include, for example, 50-900° C. and 0.1 to 101 kPa, and various combinations thereof. These conditions can be employed as a first step in the absence of silicon-containing reactant, followed a second condition of temperature and pressure in the presence of the silicon-containing reactant. Examples of temperature and pressure ranges for the latter are found throughout this disclosure.

The CVD process can be accomplished via various modes according to the art. For example, the CVD can be carried out in a static mode, wherein the particles are not agitated, and the CVD gas flows over, around, or otherwise permeates the particles to be coated. In other exemplary modes, the particles can be fluidized, for example CVD can be carried out in a fluidized bed reactor. A variety of different reactor designs can be employed in this context as known in the art, including, but not limited to, elevator kiln, roller hearth kiln, rotary kiln, box kiln, and fluidized bed designs. These designs can be combined with various silicon-containing gases to be employed as a deposition gas, including, but not limited to, silane, disilane, trisilane, tetrasilane, chlorosilane, dichlorosilane, trichlorosilane, and tetrachlorosilane.

In the case of a rotary kiln, various methods for facilitating the proper dispersion and tumbling of particles within the reactor are known in art, and provide maximal contacting of the porous carbon and the silicon-containing reactant. These methods include equipment modifications such as lifters, helical flights, various screw/impellor designs and the like. Also known in the art are strategies to load the rotary kiln with additional, non-reactive particles to facilitate dispersion and minimum agglomeration of the nanoporous carbon-based scaffold particles.

The CVD process can also employ microwaves to achieve heating the carbon particles to be processed. Accordingly, the above reactor configurations can also be combined with microwaves as part of the processing, employing engineering design principles known in the art. Without being bound by theory, carbon particle are efficient microwave absorbers and a reactor can be envisioned wherein the particles are subjected to microwaves to heat them prior to introduction of the silicon-containing gas to be deposited to the particles.

Dielectric heating is the process in which a high-frequency alternating electric field, or radio wave or microwave electromagnetic radiation heats a dielectric material. Molecular rotation occurs in materials containing polar molecules having an electrical dipole moment, with the consequence that they will align themselves in an electromagnetic field. If the field is oscillating, as it is in an electromagnetic wave or in a rapidly oscillating electric field, these molecules rotate continuously by aligning with it. This is called dipole rotation, or dipolar polarization. As the field alternates, the molecules reverse direction. Rotating molecules push, pull, and collide with other molecules (through electrical forces), distributing the energy to adjacent molecules and atoms in the material. Once distributed, this energy appears as heat.

Temperature is related to the average kinetic energy (energy of motion) of the atoms or molecules in a material, so agitating the molecules in this way increases the temperature of the material. Thus, dipole rotation is a mechanism by which energy in the form of electromagnetic radiation can raise the temperature of an object. Dipole rotation is the mechanism normally referred to as dielectric heating, and is most widely observable in the microwave oven where it operates most efficaciously on liquid water, and also, but much less so, on fats and sugars, and other carbon-comprising materials.

Dielectric heating involves the heating of electrically insulating materials by dielectric loss. A changing electric field across the material causes energy to be dissipated as the molecules attempt to line up with the continuously changing electric field. This changing electric field may be caused by an electromagnetic wave propagating in free space (as in a microwave oven), or it may be caused by a rapidly alternating electric field inside a capacitor. In the latter case, there is no freely propagating electromagnetic wave, and the changing electric field may be seen as analogous to the electric component of an antenna near field. In this case, although the heating is accomplished by changing the electric field inside the capacitive cavity at radio-frequency (RF) frequencies, no actual radio waves are either generated or absorbed. In this sense, the effect is the direct electrical analog of magnetic induction heating, which is also near-field effect (thus not involving radio waves).

Frequencies in the range of 10-100 MHz are necessary to cause efficient dielectric heating, although higher frequencies work equally well or better, and in some materials (especially liquids) lower frequencies also have significant heating effects, often due to more unusual mechanisms. Dielectric heating at low frequencies, as a near-field effect, requires a distance from electromagnetic radiator to absorber of less than ½π≈⅙ of a wavelength. It is thus a contact process or near-contact process, since it usually sandwiches the material to be heated (usually a non-metal) between metal plates taking the place of the dielectric in what is effectively a very large capacitor. However, actual electrical contact is not necessary for heating a dielectric inside a capacitor, as the electric fields that form inside a capacitor subjected to a voltage do not require electrical contact of the capacitor plates with the (non-conducting) dielectric material between the plates. Because lower frequency electrical fields penetrate non-conductive materials far more deeply than do microwaves, heating pockets of water and organisms deep inside dry materials like wood, it can be used to rapidly heat and prepare many non-electrically conducting food and agricultural items, so long as they fit between the capacitor plates.

At very high frequencies, the wavelength of the electromagnetic field becomes shorter than the distance between the metal walls of the heating cavity, or than the dimensions of the walls themselves. This is the case inside a microwave oven. In such cases, conventional far-field electromagnetic waves form (the cavity no longer acts as a pure capacitor, but rather as an antenna), and are absorbed to cause heating, but the dipole-rotation mechanism of heat deposition remains the same. However, microwaves are not efficient at causing the heating effects of low frequency fields that depend on slower molecular motion, such as those caused by ion-drag.

Microwave heating is a sub-category of dielectric heating at frequencies above 100 MHz, where an electromagnetic wave can be launched from a small dimension emitter and guided through space to the target. Modern microwave ovens make use of electromagnetic waves with electric fields of much higher frequency and shorter wavelength than RF heaters. Typical domestic microwave ovens operate at 2.45 GHz, but 915 MHz ovens also exist. This means that the wavelengths employed in microwave heating are 12 or 33 cm (4.7 or 13.0 in). This provides for highly efficient, but less penetrative, dielectric heating. Although a capacitor-like set of plates can be used at microwave frequencies, they are not necessary, since the microwaves are already present as far field type electromagnetic radiation, and their absorption does not require the same proximity to a small antenna, as does RF heating. The material to be heated (a non-metal) can therefore simply be placed in the path of the waves, and heating takes place in a non-contact process.

Microwave absorbing materials are thus capable of dissipating an electromagnetic wave by converting it into thermal energy. Without being bound by theory, a material's microwave absorption capacity is mainly determined by its relative permittivity, relative permeability, the electromagnetic impedance match, and the material microstructure, for example its porosity and/or nano- or micro-structure. When a beam of microwave irradiates the surface of an microwave absorbing material, a suitable matching condition for the electromagnetic impedance can enable almost zero reflectivity of the incident microwave, ultimately resulting in transfer of thermal energy to the absorbing material.

Carbon materials are capable of absorbing microwaves, i.e., they are easily heated by microwave radiation, i.e., infrared radiation and radiowaves in the region of the electromagnetic spectrum. More specifically, they are defined as those waves with wavelengths between 0.001 and 1 m, which correspond to frequencies between 300 and 0.3 GHz. The ability of carbon to be heated in the presence of a microwave field, is defined by its dielectric loss tangent: tan δ=ε″/ε′. The dielectric loss tangent is composed of two parameters, the dielectric constant (or real permittivity), ε′, and the dielectric loss factor (or imaginary permittivity), ε″; i.e., ε=ε′−iε″, where c is the complex permittivity. The dielectric constant (ε′) determines how much of the incident energy is reflected and how much is absorbed, while the dielectric loss factor (ε″) measures the dissipation of electric energy in form of heat within the material. For optimum microwave energy coupling, a moderate value of ε′ should be combined with high values of ε″ (and so high values of tan δ), to convert microwave energy into thermal energy. Thus, while some materials do not possess a sufficiently high loss factor to allow dielectric heating (transparent to microwaves), other materials, e.g. some inorganic oxides and most carbon materials, are excellent microwave absorbers. On the other hand, electrical conductor materials reflect microwaves. For example, graphite and highly graphitized carbons may reflect a considerable fraction of microwave radiation. In the case of carbons, where delocalized π-electrons are free to move in relatively broad regions, an additional and very interesting phenomenon may take place. The kinetic energy of some electrons may increase enabling them to jump out of the material, resulting in the ionization of the surrounding atmosphere. At a macroscopic level, this phenomenon is perceived as sparks or electric arcs formation. But, at a microscopic level, these hot spots are actually plasmas. Most of the time these plasmas can be regarded as microplasmas both from the point of view of space and time, since they are confined to a tiny region of the space and last for just a fraction of a second. An intensive generation of such microplasmas may have important implications for the processes involved.

Without being bound by theory, heating of carbon materials by microwave heating offers a number of advantages over conventional heating such as: (i) non-contact heating; (ii) energy transfer instead of heat transfer; (iii) rapid heating; (iv) selective material heating; (v) volumetric heating; (vi) quick start-up and stopping; (vii) heating from the interior of the material body; and, (viii) higher level of safety and automation [3]. The high capacity of carbon materials to absorb microwave energy and convert it into heat is illustrated in Table 1 (provided from the reference J. A. Menendez, A. Arenillas, B. Fidalgo, Y. Fernandez, L. Zubizarreta, E. G. Calvo, J. M. Bermudez, “Microwave heating processes involving carbon materials”, Fuel Processing Technology, 2010, 91 (1), 1-8), where the dielectric loss tangents of examples of different carbons are listed. As can be seen, the loss tangents of most of the carbons, except for coal, are higher than the loss tangent of distilled water (tan δ of distilled water=0.118 at 2.45 GHz and room temperature).

Given the potential for carbons to absorb microwaves, there is also a potential for microwave enhancement of carbon-catalyzed reactions, or reactions that occur on or within a carbon particle. Without being bound by theory, there are at least two scenarios where microwaves enhance such a reaction on or within a carbon particle: (i) reactions which require a high temperature, and (ii) reactions involving chemical compounds which, like the organic compounds, have a low dielectric loss and do not heat up sufficiently under microwave irradiation. With regards to the current invention, the carbon material acts as both reaction surface (e.g., catalyst) and microwave receptor.

In exemplary embodiments, the silicon (or other electrochemically active species) exists as a layer coating the inside of pores within the nanoporous carbon-based scaffold. In some embodiments, the silicon (or other electrochemically active species) exists as particles deposited the inside of pores within the nanoporous carbon-based scaffold. For example, the deposition or infiltration processes disclosed herein can result in layers, particles, conformal layers, partial layers, or combinations thereof. The layer depth or particle size of this silicon can vary, for example the layer depth or particle size can be between 5 nm and 10 nm, between 5 nm and 20 nm, between 5 nm and 30 nm, between 5 nm and 33 nm, between 10 nm and 30 nm, between 10 nm and 50 nm, between 10 nm and 100 nm, between 10 and 150 nm, between 50 nm and 150 nm, between 100 and 300 nm, between 300 and 1000 nm. In some embodiments, the layer depth or particle size can be about 5 nm, about 10 nm, about 15 nm, about 20 nm, about 25 nm, about 30 nm, about 35 nm, about 40 nm, about 50 nm, about 75 nm, about 100 nm, about 150 nm, or in a range between any two of these values.

In preferred embodiments, the silicon embedded within the composite is nano sized, and resides within pores of the nanoporous carbon-based scaffold. For example, the embedded silicon can be impregnated, deposited by CVD, CVI, or other appropriate process into pores within the porous carbon materials comprising pore sizes between 5 and 1000 nm, for example between 10 and 500 nm, for example between 10 and 200 nm, for example between 10 and 100 nm, for example between 33 and 150 nm, for example between and 20 and 100 nm. In certain embodiments, the porous carbon materials can have a pore size of about 50 nm or less, 45 nm or less, 40 nm or less, 35 nm or less, 30 nm or less, 25 nm or less, 20 nm or less, 15 nm or less, 10 nm or less, 5 nm or less, or in a range between any two of these values. Other ranges of carbon pores sizes with regards to fractional pore volume, whether micropores, mesopores, or macropores, are also envisioned.

In certain embodiments, the porous silicon particles embedded within the composite fill the pores within the nanoporous carbon-based scaffold material. As discussed above, the aerogel or aerogel-like materials of the nanoporous carbon-based scaffold material disclosed herein (without incorporation of electrochemically active species, e.g., silicon) have a relatively large pore volume of about 1 cc/g or more, 1.5 cc/g or more, 2 cc/g or more, 2.5 cc/g or more, 3 cc/g or more, 3.5 cc/g or more, 4 cc/g or more, or in a range between any two of these values. In other embodiments, aerogel materials or compositions of the present disclosure (with incorporation of electrochemically active species, e.g., silicon) have a pore volume of about 0.3 cc/g or more, 0.6 cc/g or more, 0.9 cc/g or more, 1.2 cc/g or more, 1.5 cc/g or more, 1.8 cc/g or more, 2.1 cc/g or more, 2.4 cc/g or more, 2.7 cc/g or more, 3.0 cc/g or more, 3.3 cc/g or more, 3.6 cc/g or more, or in a range between any two of these values. In certain embodiments, the aerogel or aerogel-like materials of the nanoporous carbon-based scaffold material disclosed herein have a relatively narrow pore size distribution (full width at half max) of about 50 nm or less, 45 nm or less, 40 nm or less, 35 nm or less, 30 nm or less, 25 nm or less, 20 nm or less, 15 nm or less, 10 nm or less, 5 nm or less, or in a range between any two of these values.

The percent of pore volume within the nanoporous carbon-based scaffold that is filled with silicon (or other electrochemically active species) can vary. For example, the silicon (or other electrochemically active species) embedded within the nanoporous carbon-based scaffold material can occupy between 5% and 15% of the total available pore volume within the nanoporous carbon-based scaffold. In other embodiments, the silicon (or other electrochemically active species) embedded within the nanoporous carbon-based scaffold material can occupy between 15% and 25% of the total available pore volume within the nanoporous carbon-based scaffold. In other embodiments, the silicon (or other electrochemically active species) embedded within the nanoporous carbon-based scaffold material can occupy between 25% and 35% of the total available pore volume within the nanoporous carbon-based scaffold. In other embodiments, the silicon (or other electrochemically active species) embedded within the nanoporous carbon-based scaffold material can occupy between 20% and 40% of the total available pore volume within the nanoporous carbon-based scaffold. In other embodiments, the silicon (or other electrochemically active species) embedded within the nanoporous carbon-based scaffold material can occupy between 25% and 50% of the total available pore volume within the nanoporous carbon-based scaffold. In other embodiments, the silicon (or other electrochemically active species) embedded within the nanoporous carbon-based scaffold material can occupy between 30% and 70% of the total available pore volume within the nanoporous carbon-based scaffold, for example between 30% and 60% of the total available pore volume within the nanoporous carbon-based scaffold. In other embodiments, the silicon (or other electrochemically active species) embedded within the nanoporous carbon-based scaffold material can occupy between 60% and 80% of the total available pore volume within the nanoporous carbon-based scaffold. In other embodiments, the silicon (or other electrochemically active species) embedded within the nanoporous carbon-based scaffold material can occupy between 80% and 100% of the total available pore volume within the nanoporous carbon-based scaffold.

In preferred embodiments, the silicon (or other electrochemically active species) embedded within the nanoporous carbon-based scaffold material occupies a fraction of the total available pore volume within the nanoporous carbon-based scaffold, with the remainder of the pore volume being available for the silicon (or other electrochemically active species) to expand into upon the uptake of lithium. In this context, and without being bound by theory, this remaining pore volume may or may not be accessible to nitrogen, and therefore may or may not be observed upon employing nitrogen gas sorption as disclosed herein.

Accordingly, in some embodiments, the silicon (or other electrochemically active species) embedded within the nanoporous carbon-based scaffold material can occupy between 30% and 70% of the total available pore volume within the nanoporous carbon-based scaffold, and the composite particle comprising the nanoporous carbon-based scaffold and the embedded silicon (or other electrochemically active species) have a pore volume of about 0.3 cc/g or more, 0.6 cc/g or more, 0.9 cc/g or more, 1.2 cc/g or more, 1.5 cc/g or more, 1.8 cc/g or more, 2.1 cc/g or more, 2.4 cc/g or more, 2.7 cc/g or more, 3.0 cc/g or more, 3.3 cc/g or more, 3.6 cc/g or more, or in a range between any two of these values.

In some embodiments, the silicon (or other electrochemically active species) is embedded within a fraction of the nanoporous carbon-based scaffold, and the pores are capped with a coating that surrounds the composite particle, for example this coating can comprise carbon or a conductive polymer, as described elsewhere within this disclosure. In this context, and without being bound by theory, this pore volume may not accessible to nitrogen and therefore not detectable by nitrogen sorption. However, this resulting void space within the composite particle can be ascertained by other means, for example by measuring tap density, or envelope density, for example by pycnometry techniques.

Accordingly, the composite material may comprise silicon (or other electrochemically active species) embedded within the nanoporous carbon-based scaffold material between 30% and 70% of the total available pore volume within the nanoporous carbon-based scaffold, and the composite particle comprises a tap density less than 1.3 g/cc, less than 1 g/cc, less than 0.8 g/cc, less than 0.7 g/cc, less than 0.6 g/cc, less than 0.5 g/cc, less than 0.4, less than 0.3 g/cc, f less than 0.2 g/cc, less than 0.15 g/cc, less than 0.1 g/cc, or in a range between any two of these values.

In some embodiments, the composite material may comprise silicon embedded within the nanoporous carbon-based scaffold material between 30% and 70% of the total available pore volume within the nanoporous carbon-based scaffold, and the composite particle comprises a skeletal density as determined by pycnometry less than 2.2 g/cc, less than 2.1 g/cc, less than 2.0 g/cc, less than 1.9 g/cc, less than 1.8 g/cc, less than 1.7 g/cc, less than 1.6 g/cc, less than 1.4 g/cc, less than 1.2 g/cc, than 1.0 g/cc. In certain embodiments, the composite material comprises a skeletal density between 1.8 and 2.2 g/cc, for example between 1.9 and 2.2 g/cc, for example, between 2.0 and 2.2 g/cc.

The silicon content within the composite material can be varied. For example, the silicon content within the composite can range from 5 to 95% by weight. In certain embodiments, the content of silicon within the composite can range from 10% to 80%, for example, 20% to 70%, for example 30% to 60%, for example 40 to 50%. In some embodiments, the content of silicon within the composite can range from 10% to 50%, for example, 20% to 40%, for example 30% to 40%. In other embodiments, the content of silicon within the composite can range from 40% to 80%, for example, 50% to 70%, for example 60% to 70%. In specific embodiments, the content of silicon within the composite can range from 10% to 20%. In specific embodiments, the content of silicon within the composite can range from 15% to 25%. In specific embodiments, the content of silicon within the composite can range from 25% to 35%. In specific embodiments, the content of silicon within the composite can range from 35% to 45%. In specific embodiments, the content of silicon within the composite can range from 45% to 55%. In specific embodiments, the content of silicon within the composite can range from 55% to 65%. In specific embodiments, the content of silicon within the composite can range from 65% to 75%. In specific embodiments, the content of silicon within the composite can range from 75% to 85%.

Since the total pore volume (as determined by nitrogen gas sorption) may partially relate to the storage of lithium ions, the internal ionic kinetics, as well as the available composite/electrolyte surfaces capable of charge-transfer, this is one parameter that can be adjusted to obtain the desired electrochemical properties.

Accordingly, the surface area and pore volume of the composite material can be varied. In some embodiments, the surface area of the composite be greater than 20 m²/g, greater than 30 m²/g, greater than 40 m²/g, greater than 50 m²/g, greater than 60 m²/g, greater than 70 m²/g, greater than 80 m²/g, greater than 90 m²/g, greater than 100 m²/g, greater than 200 m²/g, greater than 300 m²/g, greater than 500 m²/g, greater than 750 m²/g, or in a range between any two of these values. For example, the surface area of the composite material can range between 20 m²/g and 700 m²/g. In certain embodiments, the surface area of the composite can range between 20 m²/g and 700 m²/g, for example between 20 m²/g and 600 m²/g, for example between 20 m²/g and 500 m²/g, for example between 20 m²/g and 400 m²/g. In some embodiments, the surface area of the composite can range between 20 m²/g and 300 m²/g, for example between 20 m²/g and 200 m²/g, for example between 30 m²/g and 100 m²/g, for example between 40 m²/g and 100 m²/g.

The pore volume of the composite material can be about 0.5 cc/g or more, 1 cc/g or more, 1.5 cc/g or more, 2 cc/g or more, 2.5 cc/g or more, 3 cc/g or more, 3.5 cc/g or more, 4 cc/g or more, or in a range between any two of these values. In other embodiments, aerogel materials or compositions of the present disclosure (with incorporation of electrochemically active species, e.g., silicon) have a pore volume of about 0.1 cc/g or more, 0.3 cc/g or more, 0.6 cc/g or more, 0.9 cc/g or more, 1.2 cc/g or more, 1.5 cc/g or more, 1.8 cc/g or more, 2.1 cc/g or more, 2.4 cc/g or more, 2.7 cc/g or more, 3.0 cc/g or more, 3.3 cc/g or more, 3.6 cc/g or more, or in a range between any two of these values. In certain embodiments, the composite materials can have a relatively narrow pore size distribution (full width at half max) of about 50 nm or less, 45 nm or less, 40 nm or less, 35 nm or less, 30 nm or less, 25 nm or less, 20 nm or less, 15 nm or less, 10 nm or less, 5 nm or less, or in a range between any two of these values.

The pore volume distribution of the composite material can vary, for example the % micropores can comprise less than 30%, for example less than 20%, for example less than 10%, for example, less than 5%, for example less than 4%, for example, less than 3%, for example, less than 2%, for example, less than 1%, for example, less than 0.5%, for example, less than 0.2%, for example, less than 0.1%. In certain embodiments, there is no detectable micropore volume in the composite material exhibiting extremely durable intercalation of lithium

In some embodiments, the pore volume distribution of the composite comprises a high percentage of mesopores. For example, the composite can include greater than 50% mesopores, greater than 60% mesopores, greater than 70% mesopores, greater than 80% mesopores, or a range between any two of these values. In some embodiments, the pore volume distribution of the composite material comprises less than 30% macropores, for example less than 20% macropores, for example less than 10% macropores, for example less than 5% macropores, for example less than 4% macropores, for example less than 3% macropores, for example less than 2% macropores, for example less than 1% macropores, for example less than 0.5% macropores, for example less than 0.2% macropores, for example less than 0.1% macropores. In some embodiments, there is no detectable macropore volume in the composite material.

Certain embodiments of the pore volume distribution of the composite material comprises a variety of the embodiments of the above several paragraphs. For example, the composite material can include less than 30% micropores, less than 30% macropores, and greater than 50% mesopores. In other embodiments, the composite material can include less than 20% micropores, less than 20% macropores, and greater than 70% mesopores. In other embodiments, the composite material can include less than 10% micropores, less than 10% macropores, and greater than 80% mesopores. In other embodiments, the composite material can include less than 10% micropores, less than 10% macropores, and greater than 90% mesopores. In other embodiments, the composite material can include less than 5% micropores, less than 5% macropores, and greater than 90% mesopores. In other embodiments, the composite material can include less than 5% micropores, less than 5% macropores, and greater than 95% mesopores.

In certain embodiments, the surface layer of the composite material exhibits a low Young's modulus, in order to absorb volume deformation associated with the uptake and intercalation of lithium ions, while not fracturing or otherwise providing additional opportunity for new SEI formation. In this context, the surface layer is sufficient to provide a composite material comprising a Young's modulus less than 100 GPa, for example less than 10 GPa, for example less than 1 GPa, for example less than 0.1 GPa.

In certain embodiments, the surface layer of the composite material exhibits a low bulk modulus, in order to absorb volume deformation associated with the uptake and intercalation of lithium ions, while not fracturing or otherwise providing additional opportunity for new SEI formation. In this context, the surface layer is sufficient to provide a composite material comprising a bulk modulus less than 100 GPa, for example less than 10 GPa, for example less than 1 GPa, for example less than 0.1 GPa.

In certain other embodiments, the surface layer of the composite material exhibits a high bulk modulus, in order to restrict volume deformation associated with the uptake and intercalation of lithium ions, thus avoiding fracturing or otherwise denying additional opportunity for new SEI formation. In this context, the surface layer is sufficient to provide a composite material comprising a bulk modulus greater than 10 GPa, for example greater than 50 GPa, for example greater than 100 GPa, for example greater than 1000 GPa.

In some embodiments, the surface area of the composite material can be greater than 500 m2/g. In other embodiments, the surface area of the composite material can be less than 700 m2/g. In some embodiments, the surface area of the composite material is between 500 and 700 m2/g. In some embodiments, the surface area of the composite material is between 200 and 600 m2/g. In some embodiments, the surface area of the composite material is between 100 and 200 m2/g. In some embodiments, the surface area of the composite material is between 50 and 100 m2/g. In some embodiments, the surface area of the composite material is between 10 and 50 m2/g. In some embodiments, the surface area of the composite material is less than 10 m2/g. In some embodiments, the surface area of the composite material is less than 5 m2/g. In some embodiments, the surface area of the composite material is less than 2 m2/g. In some embodiments, the surface area of the composite material is less than 1 m2/g. In some embodiments, the surface area of the composite material is less than 0.5 m2/g. In some embodiments, the surface area of the composite material is less than 0.1 m2/g.

The surface area of the composite material may be modified through activation or etching. The activation or etching method may use steam, chemical activation, CO2 or other gasses. Exemplary methods for activation and etching of carbon material are well known in the art.

### EXAMPLES

The following examples are described for illustrative purposes only and are not intended to be limiting the scope of the various embodiments of the current invention in any way.

### Example 1: PI Composites

PI gels were prepared from pyromellitic dianhydride (PMDA) and 1,4-phenylene diamine (PDA) in a 1:1 molar ratio in DMAC solvent at target densities of 0.05 g/cc (low density) and 0.125 g/cc (high density). The precursors were mixed at room temperature for 3 hours, and then acetic anhydride (AA) was added at 4.3 molar ratio to PMDA and mixed with the solution for 2 hours. Imidization was catalyzed with pyridine (Py).

To prepare PI composites, the solutions were cast at about 6 mm thickness in a Teflon container. The gels were cured at room temperature overnight followed by ethanol exchanges at 68° C. prior to the supercritical CO₂ extraction. The PI aerogel composites were pyrolyzed under inert atmosphere for 1 hour for carbonization to form monolithic PI composites. The lower target density PI (0.05 g/cc target density) was pyrolyzed at 850° C. The resulting carbon aerogel material had a surface area of 629.9 m²/g, a pore volume of 4.0 cc/g, and a pore size of 20.8 nm. The higher target density PI (0.125 g/cc) was pyrolyzed at 1050° C. The resulting carbon aerogel material had a surface area of 553.8 m²/g, a pore volume of 1.7 cc/g, and a pore size of 10.9 nm. The parameters of porous structure were calculated from the nitrogen adsorption isotherms (S_{BET}—surface area; Vₜ—total pore volume) at −196° C. using a Quadrasorb gas sorption analyzer (Quantachrome Instruments, Boynton Beach, USA). The pore width (in nm) was estimated using Barrett-Joyner-Halenda model. The sample was out-gassed at 100 mTorr and 60° C. for 12 h prior to analysis.

### Example 2: Carbonized Polyimide Aerogel with High Pore Volume and Narrow Pore Size Distribution

PI gels were prepared by reacting 6 g of PMDA with 3 g of PDA to form polyamic acid in 100 mL of DMAC at room temperature for 2-24 hrs. Subsequently, 8.86 g of AA was added as chemical imidization reagent to the polyamic acid solution (see FIG. 20). The acidified polyamic solution was mixed vigorously for at least 2 hrs. The obtained mixture was diluted with DMAC to the desired target density of the PI aerogel. 1-4 g of Py per 100 mL of mixture was added to the final solution to promote gelation, which occurred in 4-25 min. Prior to gelation, the mixture was cast in desired form (e.g., film, monolith, in reinforced fiber, etc.). The gels obtained were then aged in the oven at 65-70° C. and washed/rinsed with ethanol several times prior supercritical drying. The PI aerogel was converted into carbon aerogel by pyrolysis at 1050° C. for 2 hrs in inert environment (nitrogen gas flow). Without being bound by theory, the physical and structural properties of the carbonized PI aerogel were dependency on the precursors mixing time and the amount of Py.

Structural properties of four CPI aerogels tested by nitrogen adsorption desorption technique are reported in Table 1. The four samples differ by time mixing and amount of Py. Target 5 density was fixed at 0.05 g/cc. Interestingly, all the samples show relatively similar surface BET, but pore size distribution and pore volume were affected by the parameters of synthesis.

TABLE 1
Physical and structural properties of different CPI aerogels.

| | Final | | | Surface | | Pore |
|---|---|---|---|---|---|---|
| | density | Mixing time ¹ | Pyridine | area | Micropore | volume |
| Sample ID | (g/cc) | (hrs) | concentration ² | (m²/g) | area (m²/g) | (cm³/g) |
| CPI1 | 0.09 | 24 | 1 | 655 | 105 | 5.34 |
| CPI2 | 0.09 | 24 | 2 | 696 | 122 | 4.84 |
| CPI3 | 0.09 | 2 | 1 | 682 | 134 | 1.99 |
| CPI4 | 0.09 | 2 | 2 | 612 | 114 | 1.15 |

¹ mixing time of the two precursors.
² amount of pyridine added for gelation (g/100 mL of solution)

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference should be disregarded.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

1. A carbon-silicon composition comprising: a composite material including a nanoporous carbon-based scaffold and a silicon-based material, the nanoporous carbon-based scaffold comprising a pore structure, the pore structure comprising a fibrillar morphology, wherein the silicon-based material is contained in the pore structure of the nanoporous carbon-based scaffold.

2. The carbon-silicon composition of claim 1, wherein the nanoporous carbon-based scaffold comprises a carbon aerogel.

3-4. (canceled)

5. The carbon-silicon composition of claim 1, wherein the silicon-based material is in the form of nanoparticles dispersed on the surface of the pore structure.

6. (canceled)

7. The carbon-silicon composition of claim 5, wherein the nanoparticles have at least one dimension in the range of about 5 nm to about 20 nm.

8. (canceled)

9. The carbon-silicon composition of claim 1, wherein the silicon-based material is in the form of a layer on the surface of the pore structure.

10. (canceled)

11. The carbon-silicon composition of claim 9, wherein the thickness of the layer is in the range of about 5 nm to about 20 nm.

12. (canceled)

13. The carbon-silicon composition of claim 1, wherein the pore structure comprises less than 30% micropores, less than 30% macropores, greater than 50% mesopores and a total pore volume greater than 0.1 cc/g.

14. The carbon-silicon composition of claim 1, wherein the pore structure comprises less than 20% micropores, less than 20% macropores, greater than 70% mesopores and a total pore volume greater than 0.1 cc/g.

15. The carbon-silicon composition of claim 1, wherein the pore structure comprises less than 10% micropores, less than 10% macropores, greater than 80% mesopores and a total pore volume greater than 0.1 cc/g.

16. The carbon-silicon composition of claim 1, wherein the composite material includes a porous interconnected silicon coated fibrillar carbon network.

17. (canceled)

18. (canceled)

19. A method for preparing a carbon-silicon composition, the process comprising:
providing a nanoporous carbon-based scaffold comprising a pore structure, the pore structure comprising a fibrillar morphology; and
heating the nanoporous carbon-based scaffold at an elevated temperature in the presence of a silicon-containing gas to impregnate silicon within the pore structure of the nanoporous carbon-based scaffold.

20. The method of claim 19, wherein the silicon impregnated within the pore structure of the nanoporous carbon-based scaffold is nano sized, and resides within pores formed by the fibrillar morphology.

21. The method of claim 19, wherein the carbon-silicon composition includes a porous interconnected silicon coated fibrillar carbon network.

22-24. (canceled)

25. The method of claim 19, further comprising providing a polyimide precursor, initiating imidization of the polyimide precursor chemically or thermally; combining the polyimide precursor with a medium that is non-miscible with the polyimide precursor, thereby forming droplets of the imidized polyimide; drying the droplets of the polyimide to yield a particulate porous polyimide material; and carbonizing the particulate porous polyimide material to provide the nanoporous carbon-based scaffold.

26. The method of claim 19, wherein the pore structure comprises less than 30% micropores, less than 30% macropores, greater than 50% mesopores and a total pore volume greater than 0.1 cc/g.

27. The method of claim 19, wherein the pore structure comprises less than 20% micropores, less than 20% macropores, greater than 70% mesopores and a total pore volume greater than 0.1 cc/g.

28. The method of claim 19, wherein the pore structure comprises less than 10% micropores, less than 10% macropores, greater than 80% mesopores and a total pore volume greater than 0.1 cc/g.

29. An energy storage device comprising the carbon-silicon composition of claim 1.

30. The energy storage device of claim 29, wherein the energy storage device is a lithium-ion battery.
